(19) United States
(12) Patent Application Publication
(10) Pub. No.: US 2022/0331690 A1
(43) Pub. Date: Oct. 20, 2022

(54) ELECTRONIC DEVICE, METHOD, AND COMPUTER READABLE STORAGE MEDIUM FOR ADAPTIVELY SWITCHING MODE OF GAME BASED ON DETECTION OF ERROR

(71) Applicant: NCSOFT Corporation, Seongnam-si (KR)

(72) Inventors: Youngdal Kwak, Seongnam-si (KR); Donghwan Kim, Seongnam-si (KR); Sanghoon Byun, Seongnam-si (KR); Sungho Woo, Seongnam-si (KR); Seungmin Lee, Seongnam-si (KR)

(73) Assignee: NCSOFT Corporation, Seongnam-si (KR)

(21) Appl. No.: 17/717,716

(22) Filed: Apr. 11, 2022

(30) Foreign Application Priority Data
Apr. 15, 2021 (KR) 10-2021-0049344

(51) Int. Cl. A63F 13/355; A63F 13/335; A63F 13/34

(52) U.S. Cl. CPC A63F 13/355; A63F 13/335; A63F 13/34

(57) ABSTRACT

According to various embodiments, when executing the communication circuit and at least one memory configured to store instructions and the instructions, the first electronic device include at least one processor configured to receive, via the communication circuit from a second electronic device that has received at least portion of first data for an execution of a game, a signal for indicating that a local mode is not available in the second electronic device, the local mode playing the game by executing in the second electronic device the game based on the first data; transmit, via the communication circuit to the second electronic device, second data for providing a cloud mode of the game to the second electronic device, based on the reception of the signal, the cloud mode playing the game by receiving, by the second electronic device, at least one content of the game executed in a third electronic device.

### CROSS-REFERENCE TO RELATED APPLICATION(S)

This application is based on and claims priority under 35 U.S.C. § 120 to Korean Patent Application No. 10-2021-0049344, filed on Apr. 15, 2021, in the Korean Intellectual Property Office, the disclosure of which are incorporated by reference herein their entirety.

### BACKGROUND

### Technical Field

Various embodiments described below relate to an electronic device, a method, and a computer-readable storage medium for adaptively switching modes of the game based on detecting the occurrence of an error related to the game.

### Description of Related Art

An online game may be a video game that is executed within each of the client devices by receiving an operation request from each of the client devices and transmitting an operation result to each of the client devices. The client devices may comprise a smartphone, a tablet computer, a desktop computer, a laptop computer, and a game console.

### SUMMARY

For an online game play, the online game may require a client device to receive data (e.g., an installation file) for executing the online game, the client device to install a program for the online game within the client device based on the received data, and the client device to execute the online game based on the installed program.

Meanwhile, when an error is caused within any one of receiving the data, installing the program, and executing the program, playing the online game using the client device may be unavailable. For example, when an error is caused within the client device or within a server providing the data during reception of the data, playing the online game using the client device may be unavailable. For another example, when an error is caused during installation of the program, playing the online game may be unavailable. For another example, when an error is caused during execution of the program, playing the online game may not be available.

The technical problems to be achieved in this document are not limited to those described above, and other technical problems not mentioned herein will be clearly understood by those having ordinary knowledge in the art to which the present disclosure belongs, from the following description.

According to various embodiments, when executing the communication circuit and at least one memory configured to store instructions and the instructions, the first electronic device may comprise at least one processor configured to receive, via the communication circuit from a second electronic device that has received at least portion of first data for an execution of a game, a signal for indicating that a local mode is not available in the second electronic device, the local mode playing the game by executing in the second electronic device the game based on the first data; transmit, via the communication circuit to the second electronic device, second data for providing a cloud mode of the game to the second electronic device, based on the reception of the signal, the cloud mode playing the game by receiving, by the second electronic device, at least one content of the game executed in a third electronic device.

According to various embodiments, a method for operating the first electronic device with a communication circuit may comprise receiving, via the communication circuit from a second electronic device that has received at least portion of first data for an execution of a game, a signal for indicating that a local mode is not available in the second electronic device, the local mode playing the game by executing in the second electronic device the game based on the first data and transmitting, via the communication circuit to the second electronic device, second data for providing a cloud mode of the game to the second electronic device, based on the reception of the signal, the cloud mode playing the game by receiving, by the second electronic device, at least one content of the game executed in a third electronic device.

According to various embodiments, when executed by at least one processor of the first electronic device with the communication circuit, a non-transitory computer readable storage medium may comprise one or more programs including instructions causing the first electronic device to receive, via the communication circuit from a second electronic device that has received at least portion of first data for an execution of a game, a signal for indicating that a local mode is not available in the second electronic device, the local mode playing the game by executing in the second electronic device the game based on the first data, and transmit, via the communication circuit to the second electronic device, second data for providing a cloud mode of the game to the second electronic device, based on the reception of the signal, the cloud mode playing the game by receiving, by the second electronic device, at least one content of the game executed in a third electronic device.

According to various embodiments, when executing the communication circuit, at least one display, at least one memory configured to store instructions, and the instructions, the first electronic device may comprise at least one processor configured to store in the at least one memory at least portion of first data for an execution of a game; receive, while a local mode playing the game by executing the game in the first electronic device by using the first data stored in the first data is unavailable, second data for accessing a third electronic device for a cloud mode of the game playing the game by receiving at least one content of the game executed in the third electronic device by the first electronic device; and display, via the at least one display, the at least one content received via the communication circuit from the third electronic device by using a communication connection between the first electronic device and the third electronic device, the communication connection established based on the second data for the play of the game through the cloud mode.

According to various embodiments, a method for operating the first electronic device with at least one memory, communication circuit, and at least one display may comprise storing in the at least one memory at least portion of first data for an execution of a game; receiving, while a local mode playing the game by executing the game in the first electronic device by using the first data stored in the first data is unavailable, second data for accessing a third electronic device for a cloud mode of the game playing the game by receiving at least one content of the game executed in the third electronic device by the first electronic device; and displaying, via the at least one display, the at least one content received via the communication circuit from the third electronic device by using a communication connection between the first electronic device and the third electronic device, the communication connection established based on the second data for the play of the game through the cloud mode.

According to various embodiments, when executed by at least one processor of the first electronic device having communication circuit, at least one memory, and at least one display, the non-transitory computer-readable storage medium may store one or more programs including instructions causing the first electronic device to store in the at least one memory at least portion of first data for an execution of a game; receive, while a local mode playing the game by executing the game in the first electronic device by using the first data stored in the first data is unavailable, second data for accessing a third electronic device for a cloud mode of the game playing the game by receiving at least one content of the game executed in the third electronic device by the first electronic device; and display, via the at least one display, the at least one content received via the communication circuit from the third electronic device by using a communication connection between the first electronic device and the third electronic device, the communication connection established based on the second data for the play of the game through the cloud mode.

The effects that can be obtained from the present disclosure are not limited to those described above, and any other effects not mentioned herein will be clearly understood by those having ordinary knowledge in the art to which the present disclosure belongs, from the following description.

### BRIEF DESCRIPTION OF THE DRAWINGS

FIG. 1 illustrates an environment including electronic devices according to various embodiments.

FIG. 2 illustrates an example of a local mode provided by an electronic device according to various embodiments.

FIG. 3 illustrates an example of a cloud mode provided in an electronic device according to various embodiments.

FIG. 4 is a simplified block diagram illustrating functional configurations of each of electronic devices according to various embodiments.

FIG. 5 illustrates an example of signaling between electronic devices according to various embodiments.

FIG. 6 illustrates examples of first data received by an electronic device according to various embodiments.

FIG. 7 is a flowchart illustrating a method of transmitting second data based on partial reception of first data according to various embodiments.

FIG. 8 is a flowchart illustrating a method of transmitting second data based on an error during game installation according to various embodiments.

FIG. 9 is a flowchart illustrating a method of transmitting second data based on an error during execution of a game in the local mode according to various embodiments.

FIG. 10 is a flowchart illustrating a method of determining to stop providing the cloud mode according to various embodiments.

FIG. 11 illustrates examples of second data received by an electronic device according to various embodiments.

FIG. 12, according to various embodiments, is a flowchart illustrating a method of determining to stop providing the cloud mode based on expiration of a period in which a game may be played via the cloud mode.

FIG. 13, according to various embodiments, is a flowchart illustrating a method of determining to stop providing the cloud mode based on identifying that the game is not played for a specified period via the cloud mode.

FIG. 14, according to various embodiments, is a flowchart illustrating a method of determining to stop providing the cloud mode based on identifying that the game's play via the local mode is activated in another electronic device.

FIG. 15, according to various embodiments, to various embodiments, is a flowchart illustrating a method of providing the cloud mode.

FIG. 16, according to various embodiments, is a flowchart illustrating a method of executing the game via the cloud mode while the local mode is not available.

FIG. 17, according to various embodiments, is a flowchart illustrating a method of receiving the second data.

FIG. 18, according to various embodiments, is a flowchart illustrating a method of maintaining or stopping playing the game via the cloud mode.

### DETAILED DESCRIPTION

According to various embodiments, an electronic device, a method, and a non-transitory computer-readable storage media can provide a service for continuously playing the game while recovering from the error by adaptively switching the mode of the game to the cloud mode based on detection of errors related to the execution of the game in the local mode.

The electronic device according to various embodiments disclosed in the present document may be various types of devices. The electronic device may comprise, for example, a portable communication device (e.g., a smartphone), a computer device, a portable multimedia device, a portable medical device, a camera, a wearable device, a server, or a home appliance. The electronic device according to an embodiment of the present document is not limited to the above-described devices.

The various embodiments and terms used herein are not intended to limit the technical features described herein to specific embodiments and should be understood to comprise various modifications, equivalents, or substitutes of the embodiment. With respect to the description of the drawings, similar reference numerals may be used for similar or related components. The singular form of the noun corresponding to the item may comprise one or a plurality of the items unless clearly indicated differently in the related context. In this document, each of the phrases such as “A or B”, “at least one of A and B”, “at least one of A or B”, “A, B or C”, “at least one of A, B or C”, and “at least one of A, B and C” may comprise any one of the phrases together, or all possible combinations thereof. Terms such as “the first”, “the second”, or “the second”, or “the second” may be used simply to distinguish a corresponding component from another corresponding component, and are not limited to other aspects (e.g., importance or order). When any component (e.g., the first) is referred to as “coupled” or “connected” in another (e.g., the second) component with or without the term “functional” or “communicational”, it means that any component may be connected to another component directly (e.g., wired), wirelessly, or via a third component.

The term “module” used herein may comprise a unit implemented in hardware, software, or firmware, and may be used interchangeably with terms such as logic, logic block, parts, or circuits, for example. The module may be a minimum unit or a part of the integrally configured component or the component that performs one or more functions. For example, according to an embodiment, the module may be implemented in the form of an application-specific integrated circuit (ASIC).

Various embodiments of the present document may be implemented as software (e.g., a program) including one or more commands stored in a non-transitory storage medium readable by a machine (e.g., electronic device 105). For example, the processor of the device (e.g., electronic device 105) may call and execute at least one of one or more commands stored from the storage medium. This makes it possible for the device to be operated to perform at least one function according to the called at least one command. The one or more commands may comprise code generated by a compiler or code that may be executed by an interpreter. The device-readable storage medium may be provided in the form of a non-transitory storage medium. Here, the term ‘non-transitory’ only means that the storage medium is a device that is tangible and does not comprise a signal (e.g., electromagnetic wave), and the term does not distinguish between a case in which data is semi-permanently stored in a storage medium and a case in which data is temporarily stored.

According to an embodiment, a method according to various embodiments disclosed in the present document may be provided by being comprised in a computer program product. Computer program products can be traded between sellers and buyers as products. Computer program products may be distributed in the form of device-readable storage media (e.g., compact disc read only memory (CD-ROM), or may be distributed directly or online (e.g., downloaded or uploaded) via an application store (e.g., Player Store™, or App Store™) between two user devices (e.g., smartphones). In the case of online distribution, at least some of the computer program products may be temporarily stored or temporarily created on a device-readable storage medium such as a manufacturer's server, a server in an application store, or a memory in a relay server.

According to various embodiments, each component (e.g., a module or program) of the above-described components may comprise a single or a plurality of objects. According to various embodiments, one or more components or operations of the above-described components may be omitted, or one or more other components or operations may be added. Alternatively, or additionally, a plurality of components (e.g., modules or programs) may be integrated into one component. In this case, the integrated component may perform one or more functions of each of the plurality of components in the same or similar manner as those performed by the corresponding component among the plurality of components before the integration. According to various embodiments, operations performed by the module, the program, or the other components may be executed sequentially, in parallel, repeatedly, or heuristic, or one or more of the operations may be executed in a different order, omitted, or one or more other operations may be added.

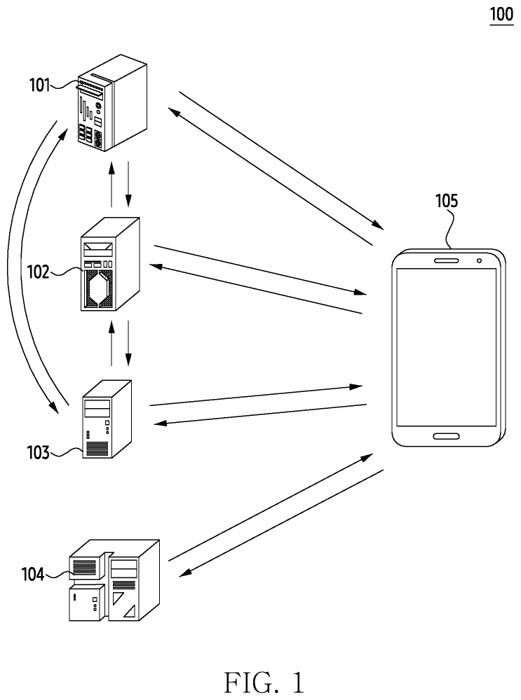

FIG. 1 illustrates an environment including electronic devices according to various embodiments.

Referring to FIG. 1, an environment 100 may comprise an electronic device 101, an electronic device 102, an electronic device 103, an electronic device 104, and an electronic device 105.

In various embodiments, the electronic device 101 may be at least one server that provides a service for a game (e.g., an online game). For example, the electronic device 101 may comprise a game server, a rate processing server, a database storing user information of the game, a database storing data for executing the game, and a database storing data related to payment transaction occurring in the game. According to embodiments, the game server, the rate processing server, the database storing the user information, the database storing the data for executing the game, and the database storing the data related to the payment transaction may be implemented as a single physical machine or multiple physical machines.

In various embodiments, the game server may process an operation request related to the game received from the electronic device 105, which is a client device, based on interworking with the database storing the data for executing the game, and may transmit information on the result of the process to the electronic device 105. In various embodiments, the game server may register a user of the electronic device 105, which is a client device, based on interworking with the database storing the user information of the game, or may execute the user authentication based at least on a relationship between account information received from the electronic device 105 and account information stored in the database storing the user information.

In various embodiments, the rate processing server may process a payment transaction caused during execution of the game based on interaction with the database storing the data related to the payment transaction. When the payment transaction is related to account transfer or credit card payment, the rate processing server may further link with an electronic device for a bank or a credit card company to process the payment transaction.

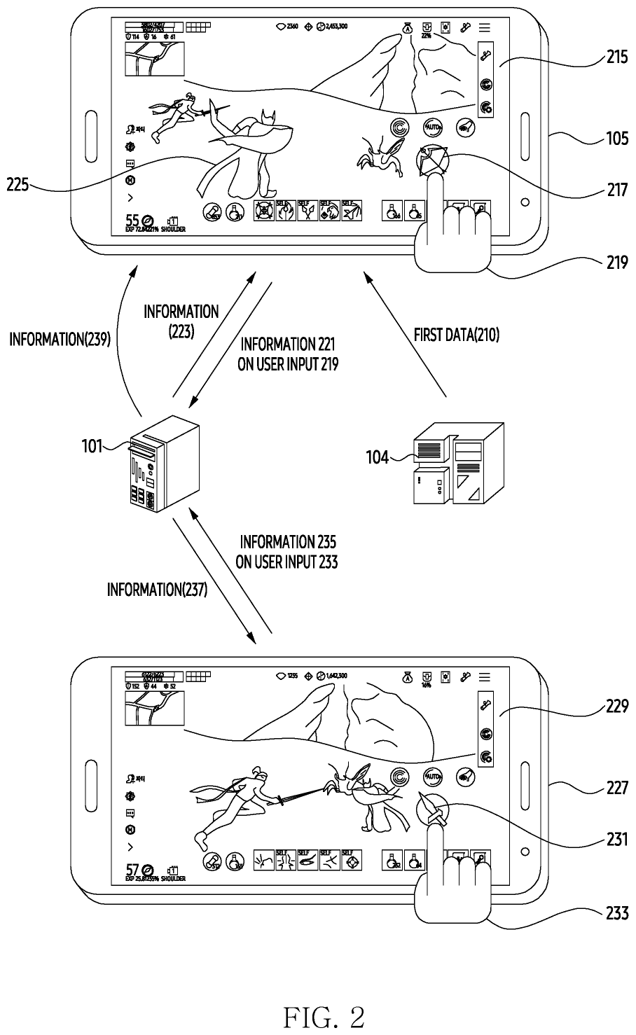

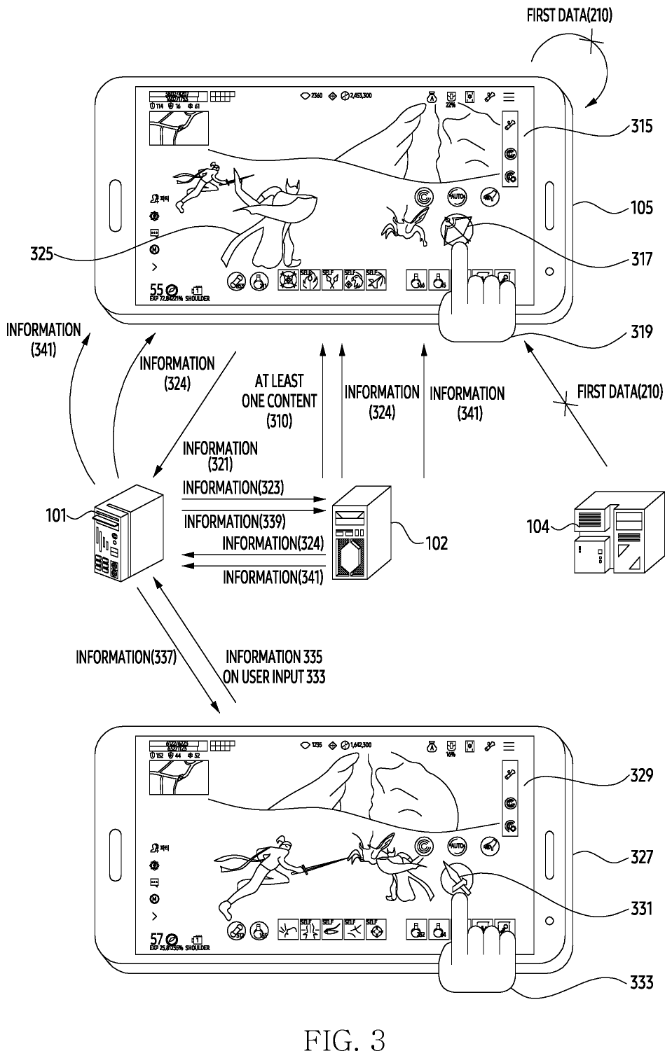

In various embodiments, the electronic device 102 may be at least one server that provides a service for executing the game based on cloud computing. In various embodiments, the game may be executed according to a local mode or may be executed according to a cloud mode. In various embodiments, when the game is executed according to the cloud mode among the local mode and the cloud mode the electronic device 102 may execute the game in the electronic device 102 and transmit information on at least one content related to the game executed in electronic device 102 to electronic device 105 for cloud mode. For example, the information on the at least one content may be directly transmitted to the electronic device 105 or may be transmitted via the electronic device 101. Meanwhile, the local mode will be described later via the description of FIG. 2, and the cloud mode will be described later via the description of FIG. 3.

In various embodiments, executing the game in electronic device 102 may be triggered based on a request from electronic device 105. The request from the electronic device 105 may be directly received from the electronic device 105 or may be received from the electronic device 105 via the electronic device 101. However, it is not limited thereto.

In various embodiments, electronic device 102 may receive data on a user input caused in relation to the at least one content displayed in electronic device 105 while executing the game in electronic device 102. For example, the data may be directly received from the electronic device 105 or may be received from the electronic device 105 via the electronic device 101. However, it is not limited thereto.

In various embodiments, electronic device 102 may change the state of the game executed in electronic device 102 based on the user input and transmit information on the changed state to electronic device 105. For example, the information may be transmitted electronically and directly or transmitted via electronic device 101. However, it is not limited thereto.

In various embodiments, electronic device 103 may be at least one server that provides a service for detecting an error related to the execution of the game. For example, the electronic device 103 may receive a signal from the electronic device 105 to indicate whether to execute the game via the local mode is not available in the electronic device 105 and may detect the error based on the signal. For example, the signal may be directly received from the electronic device 105 or may be received from the electronic device 105 via the electronic device 101.

In various embodiments, electronic device 103 may be at least one server that determines whether to switch the game mode from the local mode to the cloud mode and executes at least one operation according to the determination. For example, the electronic device 103 may determine whether to switch the mode of the game to the cloud mode based on detecting the error and may execute the at least one operation according to the determination. For example, electronic device 103 may determine whether to switch the mode of the game to the cloud mode while repairing or maintaining an error related to the execution of the game. For example, the electronic device 103 may execute the at least one operation based on interworking with at least one of the electronic device 101, the electronic device 102, or the electronic device 105. However, it is not limited thereto.

In various embodiments, electronic device 104 may be at least one server that stores data (e.g., an installation file or an installation package) for executing the game. For example, the electronic device 104 may be a device by which a service provider who provides a service related to the game (e.g., a game company) provides a space for uploading the data for installing a program (or application) related to the game in a client device (e.g., electronic device 105) using an electronic device (e.g., the electronic device 101 or another electronic device distinguished from the electronic device 101) for the designated users. For example, the data may be transmitted from an electronic device of a service provider (e.g., a game company) (e.g., the electronic device 101 or another electronic device of the service provider distinguished from the electronic device 101), and the data transmitted from the electronic device may be stored by the electronic device 104.

In various embodiments, the electronic device 104 may transmit the stored data to the electronic device 105 based on a request from the client device (e.g., the electronic device 105). For example, the request may be transmitted from electronic device 105 to electronic device 104 via a user interface (e.g., a user interface of an application for Play Store™ or a user interface of an application for App Store™) provided by electronic device 104. However, it is not limited to this.

In various embodiments, electronic device 105 may be a client device (e.g., a desktop computer, a laptop computer, a smartphone, a tablet computer, a game console, etc.) for a user playing the game. In various embodiments, electronic device 105 may be a device that displays an execution screen of the game executed within electronic device 105 or within electronic device 102. In various embodiments, electronic device 105 may be a device that receives a user input related to the game via an execution screen of the game executed within electronic device 105 or within electronic device 102.

FIG. 2 illustrates an example of a local mode provided by an electronic device according to various embodiments. The local mode may be provided in the electronic device 105 based at least on interworking of the electronic device 101, the electronic device 104, and the electronic device 105 illustrated in FIG. 1.

Referring to FIG. 2, according to various embodiments, the electronic device 104 may receive the first data 210 for installing the game from the electronic device 101 or from an electronic device) of a service provider related to the electronic device 101 (e.g., another electronic device distinguished from the electronic device 101). The electronic device 104 may store the first data 210.

In various embodiments, the electronic device 104 may transmit the first data 210 to the electronic device 105 in response to a request from the electronic device 105. For example, the electronic device 104 may transmit the first data 210 to the electronic device 105 in response to a request from the electronic device 105 via a user interface related to the electronic device 104, which is displayed via the display of the electronic device 105. For example, the first data 210 may be used for installation of the game. For example, the first data 210 may comprise more than one file for installing more than one program for executing the game. However, it is not limited thereto.

Meanwhile, the electronic device 105 may receive the first data 210 from the electronic device 104. For example, the electronic device 105 may receive the first data 210 from the electronic device 104 for the local mode.

In various embodiments, electronic device 105 may install more than one program based on the received first data 210. For example, the electronic device 105 may install more than one program by executing more than one file comprised in the first data 210 for the local mode. In various embodiments, electronic device 105 may execute the game via the local mode by executing the installed more than one program. In other words, the local mode may mean a mode of playing the game by executing the game in the electronic device 105 based on the first data 210. For example, the local mode may mean a mode of playing the game by executing the game based on information (e.g., one or more programs) obtained by the electronic device 105 from the first data 210. For example, electronic device 105 may display an execution screen 215 of the game within the local mode.

In various embodiments, the electronic device 105 may receive a user input on at least one object comprised in the execution screen 215 while displaying the execution screen 215 of the game in the local mode. For example, while displaying the execution screen 215 of the game in the local mode, the electronic device 105 may receive a user input 219 for executable objects 217 (e.g., executable objects in a bow shape) in the execution screen 215. In various embodiments, the electronic device 105 may transmit information 221 on the user input 219 to the electronic device 101 in response to receiving the user input 219 within the local mode. In response to receiving the information 221, the electronic device 101 may transmit information 223 for changing the state of the game execution screen 215 within the local mode according to the information 221 to the electronic device 105. The electronic device 105 may change the state of the game execution screen 215 based on the information 223 received from the electronic device 101 within the local mode. For example, based on the information 223, the electronic device 105 may change the state of the visual object 225 related to the user input 219 in the game execution screen 215 from the first state (e.g., a state in which the visual object 225 with the bow does not fire an arrow) to the second state (e.g., a state in which the visual object 225 with the bow fires an arrow).

Meanwhile, the electronic device 105 may change the state of the execution screen of the game displayed while executing the game via the local mode based on a user input (e.g., user input 219) caused in the electronic device 105 as well as in another client device 227 distinguished from the electronic device 105. For example, while the electronic device 105 executes the game in the local mode, another client device 227 may receive a user input on at least one object in the game execution screen 229 displayed via the display of another client device 227. For example, while the electronic device 105 executes the game in the local mode, another client device 227 may receive a user input 233 on the executable object 231 on the execution screen 229. In various embodiments, another client device 227 may transmit information 235 on user input 233 to electronic device 101 in response to receiving user input 233. In response to receiving the information 235, the electronic device 101 may transmit information 237 for changing the state of the game execution screen 229 to another client device 227 according to the information 235. In response to receiving the information 235, the electronic device 101 may transmit information 239 for changing the state of the game execution screen (e.g., execution screen 215) displayed via the display of the electronic device 105 to the electronic device 105. Another client device 227 may change the state of the game execution screen 229 based on information 237, and electronic device 105 may change the state of the game execution screen (e.g., execution screen 215) executed in the local mode based on information 239. In other words, according to various embodiments, while executing the game in the local mode electronic device 105 may change the state of the game execution screen provided in the local mode based on information on a user input caused in electronic device 105 as well as information on a user input caused in another client device 227.

Although not illustrated in FIG. 2, when the first data 210 is updated to execute the game in the local mode, the electronic device 104 may receive the updated first data 210 from the electronic device 101 or from the service provider's electronic device related to the electronic device 101 (e.g., another electronic device distinguished from the electronic device 101). The electronic device 104 may store the updated first data 210 and transmit a message for notifying to the electronic device 105 that the update of the first data 210 is available.

In various embodiments, electronic device 105 may receive the message from electronic device 104 and receive the updated first data 210 from electronic device 104 based on a user input to the message. In various embodiments, electronic device 105 may update more than one programs for executing the game in the local mode based on the updated first data 210 received from electronic device 104. In various embodiments, electronic device 105 may execute the game via the local mode by executing the updated one or more programs after the update of the one or more programs is completed. In various embodiments, electronic device 105 may interwork with at least one of electronic device 101 or another client device 227 while executing the game in the local mode based on the updated more than one program. For example, the electronic device 105 may transmit information 221 to the electronic device 101 while executing the game in the local mode base on the updated one or more program, receive information 223 from the electronic device 101, or receive information 239 obtained by the electronic device 101 from another client device 227.

FIG. 3 illustrates an example of a cloud mode provided in an electronic device according to various embodiments. The cloud mode may be provided in the electronic device 105 based at least on interworking of the electronic device 101, the electronic device 102, and the electronic device 105 shown in FIG. 1.

Referring to FIG. 3, 105 according to various embodiment, the electronic device 105 may directly access the electronic device 102 or may access the electronic device 102 via the electronic device 101 for the cloud mode. For example, for the cloud mode, the electronic device 105 may directly access the electronic device 102 using the user's account information of the electronic device 105 or may access the electronic device 102 via an intermediate node (e.g., the electronic device 101). In various embodiments, electronic device 105 may establish a communication connection between electronic device 102 and electronic device 105 via interworking with electronic device 102 based on the connection to electronic device 102. After establishing the communication connection, electronic device 102 may execute the game in electronic device 102 based on the account information. The electronic device 102 may transmit at least one content of the game executed in the electronic device 102 to the electronic device 105. For example, the at least one content may be at least one content constituting an execution screen of the game displayed via the display of the electronic device 105. For example, the at least one content may comprise at least one of at least one visual object or at least one executable object.

Meanwhile, electronic device 105 may receive at least one content of the game executed in electronic device 102 from electronic device 102 for the cloud mode. The electronic device 105 may display the at least one content received from the electronic device 102 via the display of the electronic device 105 to play the game in the cloud mode. In other words, the cloud mode may refer to a mode in which the electronic device 105 receives the at least one content of the game executed in the electronic device 102 distinguished from the electronic device 105 to play the game. For example, the electronic device 105 may provide a service for playing the game by displaying the at least one content received from the electronic device 102 without receiving the first data 210 defined via the description of FIG. 2 in the cloud mode. For another example, even if the first data 210 is received from the electronic device 104 within the cloud mode, the electronic device 105 may provide a service for playing the game by displaying the at least one content received from the electronic device 102 without using the first data 210 or the information obtained from the first date 210 (e.g., more than one file or program defined via the description of FIG. 2).

For example, the electronic device 105 may display the game execution screen 315 by receiving at least one content 310 of the game executed in the electronic device 102 within the cloud mode from the electronic device 102 and displaying at least one content 310 received from the electronic device 102 via the display of electronic device 105. In various embodiments, the execution screen 315 of the game may be distinguished from the execution screen 215 of the game in that the execution screen 315 of the game is provided based on one or more programs executed by the electronic device 102 and the execution screen of the game 215 is provided based on more than one programs executed by the electronic device 105. For example, the amount of traffic between electronic device 105 and at least one other electronic device (e.g., at least one of electronic device 101 or electronic device 102) while displaying the game's execution screen 215 315 in the cloud mode may be greater than the amount of traffic between electronic device 105 and electronic device 101 while displaying the game's execution screen 215 in the local mode. For another example, while an operation required in the electronic device 105 to display the game's execution screen 215 in the local mode is an operation of executing one or more programs obtained based on the first data 210 in the electronic device 105, the operations required in the electronic device 105 to display the execution screen of the game 315 in the cloud mode may be an operation to receive data for displaying the game's execution screen 315 and to display the execution screen of the game 315 based on the received date. In other words, the electronic device 105 may display the game execution screen 315 in the cloud mode without using the first data 210 and using the one or more programs obtained based on the first data 210.

In various embodiments, the electronic device 105 may receive a user input for at least one object comprised in the execution screen 315 while displaying the execution screen 315 of the game in the cloud mode. For example, while displaying the execution screen 315 of the game in the cloud mode, the electronic device 105 may receive a user input 319 for executable objects 317 (e.g., executable objects in a bow shape) in the execution screen 315. In various embodiments, the electronic device 105 may transmit information 321 on the user input 319 to the electronic device 101 in response to receiving the user input 319 within the cloud mode. The electronic device 101, in response to receiving the information 321, may transmit information 323 for changing the state of the game execution screen 315 to the electronic device 102 according to the information 321. The electronic device 102 may obtain information 324 for changing the state of the game execution screen 315 based on the information 323 received from the electronic device 101. For example, the information 324 may be obtained within the cloud mode to change the state of visual object 325 related to user input 319 in execution screen 315 displayed via the display of electronic device 105 from the first state (e.g., a state in which visual object 325 does not fire an arrow) to a second state (e.g., a state in which visual object 325 fires an arrow). The electronic device 102 may transmit the obtained information 324 to the electronic device 105 via the electronic device 101 or may directly transmit to the electronic device 105.

Meanwhile, in various embodiments, the electronic device 105 may receive information 324 while displaying the game execution screen 315 based on at least one content 310 received from the electronic device 102 in the cloud mode. In various embodiments, the electronic device 105 may change the state of execution screen 315 of the game in the cloud mode based on information 324. For example, the electronic device 105 may change the state of the visual object 325 in the game execution screen 315 from the first state to the second state based on the information 324 in the cloud mode.

Meanwhile, the electronic device 105 may change the state of the game execution screen displayed while executing the game in the cloud mode based on a user input (e.g., user input 319) caused in the electronic device 105 as well as a user input caused in another client device 327 distinguished from the electronic device 105. For example, a user input on at least one object in the game execution screen 329 displayed via the display of another client device 327 may be received. For example, while the electronic device 105 executes the game in the cloud mode, another client device 327 may receive a user input 333 on the executable object 331 in the execution screen 329. In various embodiments, another client device 327 may transmit information 335 on user input 333 to electronic device 101 in response to receiving user input 333. In response to receiving the information 335, the electronic device 101 may transmit information 337 for changing the state of the game execution screen 329 according to the information 335 to another client device 327. Another client device 327 may change the state of the game execution screen 329 based on the information 337.

Meanwhile, in response to receiving the information 335, the electronic device 101 may transmit information 339 for changing the state of the game execution screen (e.g., the execution screen 315) displayed via the display of the electronic device 105 to the electronic device 102 according to the information 335. The electronic device 102 may generate or obtain information 341 for changing the execution state of the game executed for the cloud mode of the electronic device 105 based on information 339 and changing the state of the execution screen (e.g., the execution screen 315) displayed via the display of the electronic device 105 in the cloud mode. The electronic device 102 may directly transmit the generated or obtained information 341 to the electronic device 105 or transmit the generated or obtained information to the electronic device 105 via the electronic device 101. The electronic device 105 may change the state of the game execution screen (e.g., the execution screen 315) provided in the cloud mode based on information 341 received directly from the electronic device 102 or received via the electronic device 101 from the electronic device 102. In other words, the electronic device 105 according to various embodiments may change the state of the game execution screen provided in the cloud mode based on information on a user input caused in the electronic device 105 as well as information on a user input caused in another client device 327 while executing the game in the cloud mode.

The cloud mode defined via the description of FIG. 3 may provide enhanced usability because it does not require operations for designating the electronic device 102 or authenticating the electronic device 102 in terms of the electronic device 105. In various embodiments, since the cloud mode is provided via a virtual machine (VM) generated by at least some of the plurality of devices when the electronic device 102 is composed of a plurality of devices, resource efficiency may be enhanced compared to a service configuring a resource using one device. In various embodiments, since the cloud mode is executed and provided within the electronic device 102 configured to be suitable for the game, it may provide an optimized environment for the game.

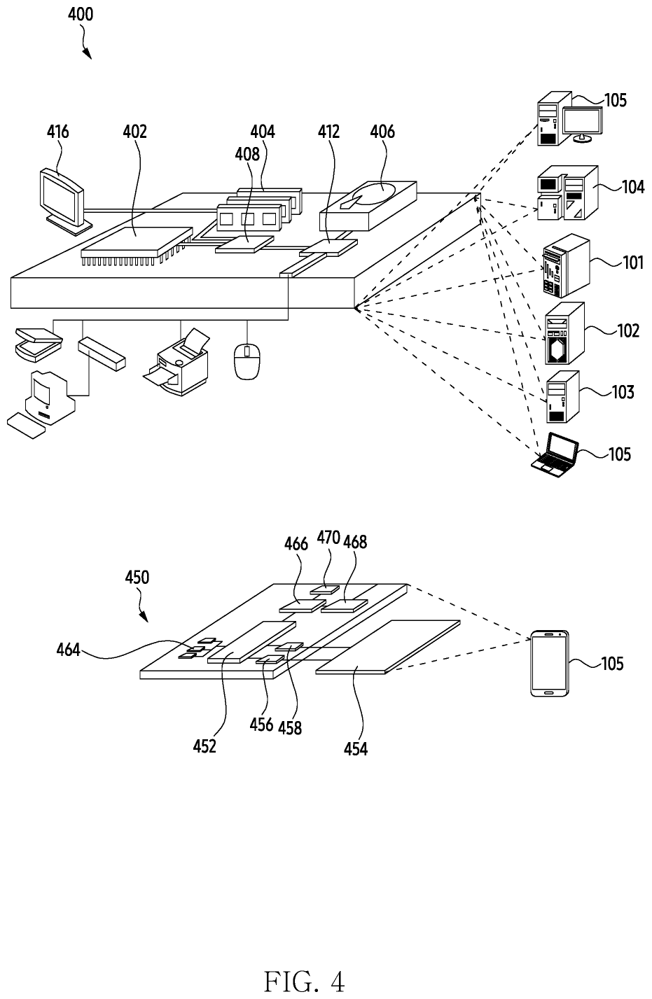

FIG. 4 is a simplified block diagram illustrating functional configurations of each of electronic devices according to various embodiments.

Referring to FIG. 4, the electronic device 400 may be an example of the electronic device 101, the electronic device 102, the electronic device 103, the electronic device 104, or the electronic device 105. The electronic device 400 may comprise a processor 402, a memory 404, a storage device 406, a high-speed controller 408 (e.g., a north bridge, a main controller hub (MCH)), and a low-speed controller 412 (e.g., a south bridge), an ICH (I/O (input/output) controller hub). In the electronic device 400, each of the processor 402, the memory 404, the storage device 406, the high speed controller 408, and the low speed controller 412 may be interconnected using various buses.

For example, the processor 402 may process instructions for execution within the electronic device 400 to display graphic information on a graphical user interface (GUI) on an external input/output device such as a display 416 connected to the high-speed controller 408. The instructions may be comprised in the memory 404 or the storage device 406. When executed by processor 402, the instructions may cause electronic device 400 to perform more than one operation described above and/or more than one operation to be described below. According to embodiments, the processor 402 may be composed of a plurality of processors including a communication processor and a graphical processing unit (GPU).

For example, the memory 404 may store information in the electronic device 400. For example, the memory 404 may be a volatile memory unit or units. As another example, memory 404 may be a nonvolatile memory unit or units. As another example, memory 404 may be another type of a non-transitory computer readable medium, such as a magnetic or optical disk.

For example, the storage device 406 may provide a mass storage space to the electronic device 400. For example, the storage device 406 may be a non-transitory computer readable medium, such as a hard disk device, an optical disk device, a flash memory, a solid state memory device, or an array of devices in a storage area network (SAN).

For example, the high speed controller 408 may manage bandwidth-intensive operations for the electronic device 400, while the low speed controller 412 may manage low bandwidth-intensive operations for the electronic device 400. For example, the high speed controller 408 is coupled to the memory 404 and coupled to the display 416 via a coupled GPU or accelerator, whereas the low speed controller 412 is coupled to the storage device 406 and may be coupled to the various communication ports (e.g., USB, Bluetooth, Ethernet, and wireless Ethernet) for a communication with an external electronic device (e.g., keyboard, transducer, scanner, or network device (e.g., a switch or a router).

The electronic device 450 may be an example of the electronic device 105. The electronic device 450 may comprise an input/output device, a communication interface 466, and a transceiver 468, such as a processor 452, a memory 464, a display 454 (e.g., an organic light emitting diode (OLED) display or other suitable display). Each of the processor 452, the memory 464, the input/output device, the communication interface 466, and the transceiver 468 may be interconnected using various buses.

For example, the processor 452 may process instructions comprised in the memory 464 to display graphic information about the GUI on the input/output device. When executed by processor 452, the instructions may cause electronic device 450 to perform one or more operations described above and/or one or more operations to be described below. For example, processor 452 may interact with the user via display interface 456 and control interface 458 coupled to display 454. For example, the display interface 456 may comprise a circuit for driving the display 454 to provide visual information to the user, and the control interface 458 may comprise a circuit for converting the commands to receive and provide commands received from the user to the processor 452. According to embodiments, the processor 452 may be implemented as a chipset of chips comprising analog and digital processors.

For example, the memory 464 may store information in the electronic device 450. For example, memory 464 may comprise at least one of one or more volatile memory units, one or more nonvolatile memory units, or a non-transitory computer readable medium.

For example, the communication interface 466 may perform wireless communication between the electronic device 450 and the external electronic device via various communication techniques such as cellular communication techniques, Wi-Fi communication techniques, NFC techniques, or Bluetooth communication techniques, based on interworking with the processor 452. For example, the communication interface 466 may be coupled to the transceiver 468 to perform the wireless communication. For example, the communication interface 466 may be further coupled to a global navigation system (GNSS) receiving module 470 to obtain location information of the electronic device 450.

As described above, according to various embodiments, a non-transitory computer readable storage medium (e.g., storage device 406), when executed by at least one processor of the first electronic device (e.g., the electronic device 103) which has a communication circuit (e.g., a communication circuit related to communication ports coupled to the low speed controller 412), may store one or more programs comprising instructions causing the first electronic device to receive, via the communication circuit from a second electronic device that has received at least portion of first data for an execution of a game, a signal for indicating that a local mode is not available in the second electronic device, the local mode playing the game by executing in the second electronic device the game based on the first data and transmit, via the communication circuit to the second electronic device, second data for providing a cloud mode of the game to the second electronic device, based on the reception of the signal, the cloud mode playing the game by receiving, by the second electronic device, at least one content of the game executed in a third electronic device.

In various embodiments, the first data may comprise an application programming interface (API) for identifying whether the local mode is available in the second electronic device or not, wherein the signal may be obtained based on the API and may be transmitted from the second electronic device to the first electronic device. In various embodiments, the first data may further comprise information for installing the game in the second electronic device to play the game in the second electronic device through the local mode in the second electronic device. In various embodiments, the API in the first data may be received in the second electronic device before the information in the first data is received in the second electronic device. In various embodiments, when executed by the at least one processor of the first electronic device, the one or more programs may comprise instructions which cause the first electronic device to receive, from the second electronic device via the communication circuit, the signal obtained based on the API in the first data; identify that the local mode is not available in the second electronic device, by identifying that the information in the first data is not fully received, based on the signal; and transmit, based on identifying that the local mode is not available in the second electronic device, the second data, via the communication circuit to the second electronic device.

In various embodiments, the one or more programs may comprise instructions which, when executed by the at least one processor of the first electronic device, cause the first electronic device to receive, from the second electronic device via the communication circuit, the signal obtained by the API in the first data; identify that the local mode is not available in the second electronic device, by identifying, based on the signal, that an error is occurred while installing the game in the second electronic device based on the information in the first data for the local mode; and transmit, based on identifying that the local mode is not available in the second electronic device, the second data, via the communication circuit to the second electronic device.

In various embodiments, the one or more programs may comprise instructions which, when executed by the at least one processor of the first electronic device, cause the first electronic device to receive, from the second electronic device via the communication circuit, the signal obtained based on the API in the first data; identify that the local mode is not available in the second electronic device, by identifying, based on the signal, that an error is occurred while playing the game in the second electronic device through the local mode; and transmit, based on identifying that the local mode is not available in the second electronic device, the second data, via the communication circuit to the second electronic device.

In various embodiments, the one or more programs may comprise instructions which, when executed by the at least one processor of the first electronic device, further cause the first electronic device to receive, from the second electronic device via the communication circuit, another signal for determining whether maintaining to provide the cloud mode to the second electronic device or not, after transmitting the second data; determine, based on the other signal, ceasing to provide the cloud mode to the second electronic device; and execute at least one operation for ceasing to play the game in the second electronic device through the cloud mode, based on the determination. In various embodiments, the second data may comprise an application programming interface (API) for identifying whether maintaining to provide the cloud mode to the second electronic device, and wherein the other signal may be obtained based on the API and transmitted from the second electronic device to the first electronic device. In various embodiments, the API may be transmitted from the first electronic device to the second electronic device before playing the game in the second electronic device through the cloud mode. In various embodiments, the one or more programs may comprise instructions which, when executed by the at least one processor of the first electronic device, further cause the first electronic device to receive, from the second electronic device via the communication circuit, the other signal obtained based on the API in the second data; and determine to cease providing the cloud mode to the second electronic device, by identifying based on the other signal that a period capable of playing the game in the second electronic device through the cloud mode.

In various embodiments, the one or more programs may comprise instructions which, when executed by the at least one processor of the first electronic device, further cause the first electronic device to receive, from the second electronic device via the communication circuit, the other signal obtained based on the API in the second data; and determine to cease providing the cloud mode to the second electronic device, by identifying based on the other signal to play the game in the second electronic device through the cloud mode during a predetermined period after receiving the second data.

In various embodiments, the one or more programs may comprise instructions which, when executed by the at least one processor of the first electronic device, further cause the first electronic device to identify, after transmitting the second data, whether identification information of a user of the second electronic device is used for playing the game in a fourth electronic device distinct from the second electronic device through the local mode; and transmit, based on identifying that the identification information is used for playing the game in the fourth electronic device through the local mode, third data for ceasing to play the game in the second electronic device through the cloud mode.

As described above, according to various embodiments, a non-transitory computer readable storage medium may store one or more programs, the one or more programs comprising instructions which, when executed by at least one processor (e.g., processor 402 or processor 452) of a first electronic device (e.g., the electronic device 105) with at least one display (e.g., display 416 or display 454), at least one memory (e.g., memory 404 or memory 464), and a communication circuit (e.g., a communication circuit related to communication ports operatively coupled to the low speed controller 412 or communication interface 466), cause the first electronic device to store in the at least one memory at least portion of first data for an execution of a game; receive, while a local mode playing the game by executing the game in the first electronic device by using the first data stored in the first data is unavailable, second data for accessing a third electronic device for a cloud mode of the game playing the game by receiving at least one content of the game executed in the third electronic device by the first electronic device; and display, via the at least one display, the at least one content received via the communication circuit from the third electronic device by using a communication connection between the first electronic device and the third electronic device, the communication connection established based on the second data for the play of the game through the cloud mode.

In various embodiments, the at least portion of the first data stored in the at least one memory may comprise an application programming interface (API) for identifying whether the local mode is available in the first electronic device, and the one or more programs may comprise instructions which, when executed by the at least one processor of the first electronic device, further cause the first electronic device to transmit, based on the API, a signal for indicating whether the local mode is available in the first electronic device or not, via the communication circuit to the second electronic device; and receive, in response to the signal, the second data via the communication circuit from the second electronic device. In various embodiments, the first data may further comprise information for installing the game in the first electronic device for playing the game in the first electronic device through the local mode, wherein the API in the first data may be received at the first electronic device, before the information in the first data is received at the first electronic device. In various embodiments, the signal may comprise data for indicating that the information in the first data is not fully received at the first electronic device, and wherein the data may be obtained based on the API included in the at least portion of the first data.

In various embodiments, the signal may comprise data for indicating that an error is caused while installing the game in the first electronic device based on the information in the first data, and wherein the data may be obtained based on the API.

In various embodiments, the second data may comprise an application programming interface (API) for identifying whether to maintaining to provide the cloud mode in the first electronic device, wherein the one or more programs may comprise instructions which, when executed by the at least one processor of the first electronic device, further cause the first electronic device to transmit, via the communication circuit to the second electronic device, another signal for determining whether maintaining to provide the cloud mode in the first electronic device, the other signal is obtained based on the API in the second data; and maintain or cease to play the game in the first electronic device through the cloud mode, according to a determination executed in the second electronic device based on the other signal.

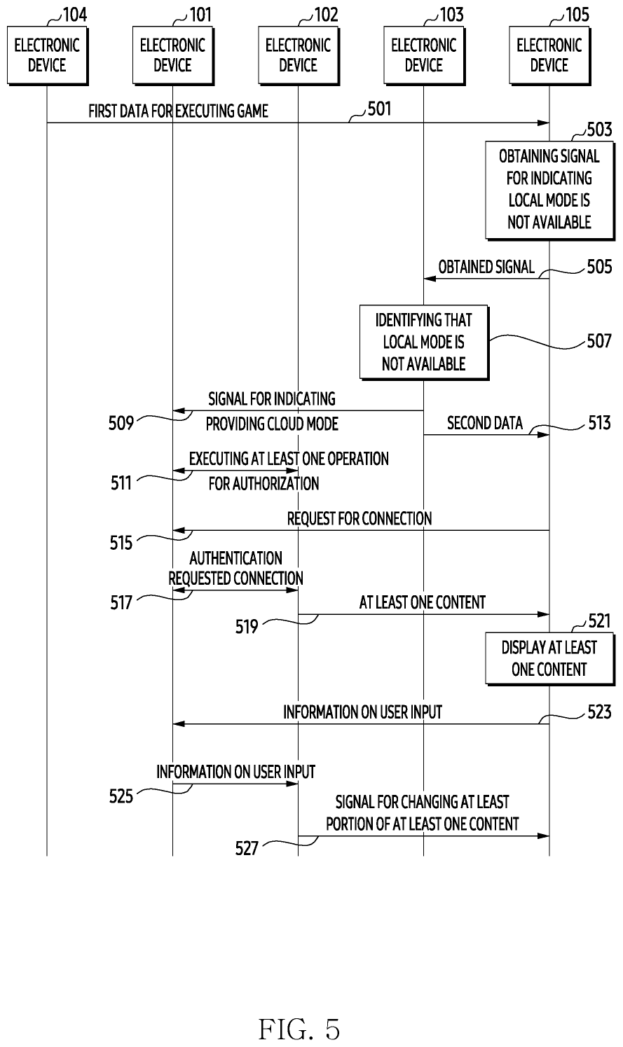

FIG. 5 illustrates an example of signaling between electronic devices according to various embodiments. Such signaling may be caused by the electronic device 101 and the electronic device 105 illustrated in FIGS. 1 to 4, the electronic device 102 illustrated in FIGS. 1, 3, and 4, the electronic device 104 illustrated in FIGS. 1, 2, and 4, and the electronic device 103 illustrated in FIGS. 1 and 4.

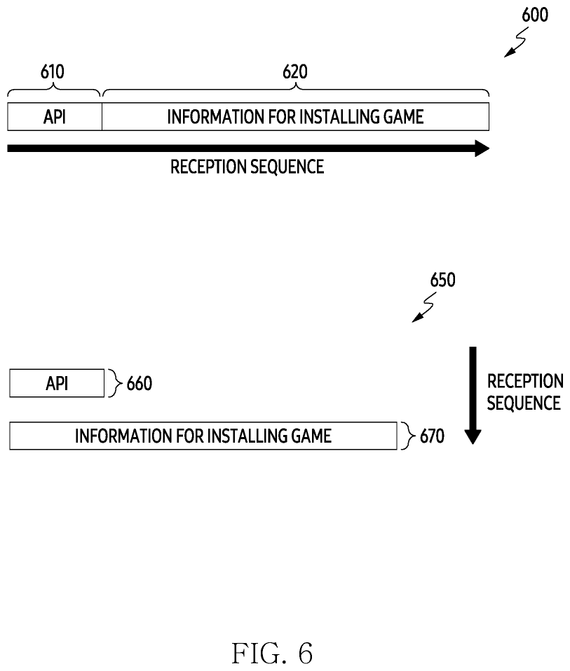

FIG. 6 illustrates examples of the first data received by an electronic device according to various embodiments.

Referring to FIG. 5, in operation 501, the electronic device 104 may transmit the first data for executing the game to the electronic device 105. For example, the first data may be the first data defined through the description of FIG. 2, and may be data for installing the game for the local mode of the game. For example, the first data may comprise the first data 210 defined through the description of FIG. 2 or the updated first data 210. In various embodiments, electronic device 105 may receive at least portion of the first data from the electronic device 104. For example, when the quality of the communication connection between the electronic device 104 and the electronic device 105 is good, the electronic device 105 may receive all of the first data, and when the quality of the communication connection between the electronic device 104 and the electronic device 105 is poor, the electronic device 105 may receive a part of the first data, and may not receive the remaining part of the first data. As another example, when the entire first data format received from the electronic device 104 is supported by the electronic device 105, the electronic device 105 may receive the entire first data, and when the any part of the format of the first data received from the electronic device 104 is not supported by the electronic device 105, the electronic device 105 may receive a part of the first data and may not receive the remaining part of the first data.

In various embodiments, the first data may comprise an application programming interface (API) for identifying whether the local mode is available in the electronic device 105. In various embodiments, the first data may further comprise information for installing the game (or one or more programs for executing the game in the local mode) in the electronic device 105 to play the game in the local mode. For example, unlike the information, the API in the first data may be configured to be received to the electronic device 105. For example, the API in the first data may be configured to be received in the electronic device 105 before the information in the first data is received in the electronic device 105. For example, the API in the first data may be configured to be transmitted from the electronic device 104 to the electronic device 105 before the information in the first data. For example, the API in the first data may be configured to be received in the electronic device 105 in a situation other than when the communication connection between the electronic device 104 and the electronic device 105 is disconnected. In other words, the API in the first data may be configured to be robust to noise. For example, the API in the first data may be configured to be available regardless of the type of electronic device. In other words, the API in the first data may be configured to have universality.

For example, referring to FIG. 6, the first data may be configured as in format 600. For example, the first data is configured as single packet and may comprise API 610 for identifying whether the local mode is available in the electronic device 105 and information 620 for installing the game. The first data configured as single packet may be configured such that the electronic device 105 receives the information 620 after receiving the API 610 from the electronic device 104. For example, API 610 may be configured to have universality and be robust to noise. For example, the API 610 received in the electronic device 105 may be configured for monitoring whether information 620 is received in the electronic device 105 after reception of the API 610.

For another example, referring to FIG. 6, the first data may be configured, such as format 650. For example, the first data may be configured as f a plurality of packets. For example, the plurality of packets may comprise a packet 660 including an API for identifying whether the local mode is available in the electronic device 105 and a packet 670 including information for installing the game. The packet 660 may be configured such that the electronic device 105 receives the packet 670 after receiving the packet 660 from the electronic device 104. For example, the packet 660 may be configured to have universality and be robust to noise. For example, the packet 660 received in the electronic device 105 may monitor whether the packet 670 is received in the electronic device 105 after the packet 660 is received.

In operation 503, the electronic device 105 may obtain a signal for indicating that the local mode is not available. In various embodiments, when the local mode is not available in the electronic device 105 after receiving at least portion of the first data from the electronic device 102, the electronic device 105 may obtain a signal for indicating that the local mode for playing the game is not available by executing the game in the electronic device 105 based on the first data. For example, when only a part of the first data is received from the electronic device 104 and the remaining part of the first data is not received, the electronic device 105 may obtain the signal based on the API. For another example, when installing one or more programs for the local mode of the game based on the first data after receiving all of the first data from the electronic device 104 is not initiated, the electronic device 105 may obtain the signal based on the API. For another example, when an error occurs while installing the one or more programs in the electronic device 105 based on the first data after receiving all of the first data from the electronic device 104, the electronic device 105 may obtain the signal based on the API. For another example, when to execute the one or more programs is not initiated after successfully installing the one or more programs based on the first data, the electronic device 105 may obtain the signal based on the API. For another example, when an error occurs while executing the one or more programs based on the first data, the electronic device 105 may obtain the signal based on the API. For another example, when only portion of the first data for updating the local mode of the game is received and the remaining part of the first data is not received, the electronic device 105 may obtain the signal based on the API. For another example, when to update the one or more programs for the local mode of the game is not initiated based on the first data after receiving all of the first data for updating the local mode of the game, the electronic device 105 may obtain the signal based on the API. For another example, when an error occurs while updating the one or more programs for the local mode of the game based on the first data for updating the local mode, the electronic device 105 may obtain the signal based on the API. For another example, when to execute the updated one or more programs is not initiated after successfully updating the one or more programs based on the first data, the electronic device 105 may obtain the signal based on the API. For another example, when an error occurs while executing the one or more programs updated based on the first data, the electronic device 105 may obtain the signal based on the API. However, it is not limited thereto.

The description of the operation 503 described above describes an example in which the electronic device 105 obtains the signal for indicating that the local mode is not available, but the signal may be obtained to indicate that the local mode is available based on the API. In other words, the signal may comprise information for indicating that the local mode is available in the electronic device 105 or information for indicating that the local mode is not available in the electronic device 105. For example, the electronic device 105 may obtain the signal for identifying whether the local mode is available or not in the electronic device 105.

In operation 505, the electronic device 105 may transmit the obtained signal to the electronic device 103. The electronic device 103 may receive the signal from the electronic device 105.

In operation 507, when the received signal indicates that the local mode is not available in the electronic device 105, the electronic device 103 may identify that the local mode is not available in the electronic device 105. For example, the received signal may comprise the information for indicating the size of at least portion of the first data received from the electronic device 104 to the electronic device 105. The electronic device 103 may identify that the local mode is not available in the electronic device 105, based on identifying that the size of at least portion of the first data indicated by the information is smaller than the size of all the first data stored in the electronic device 104. For another example, the received signal may include information indicating whether the operation of an installation interface provided while installing the one or more programs for the local mode of the game is ceased based on the first data in the electronic device 105. The electronic device 103 may identify that the local mode is not available in the electronic device 105 based on identifying a cease in operation of the installation interface from the information. For another example, the received signal may comprise information indicating whether a state of an installation interface provided while installing the one or more programs based on the first data in the electronic device 105 is a response state or an unresponsive state. The electronic device 103 may identify that the local mode is not available in the electronic device 105 based on identifying from the information that the state of the installation interface is the unresponsive state. For another example, the received signal may comprise information for indicating whether the reception rate of the first data of the electronic device 105 is less than a designated number (e.g., less than 1%) for a designated time period (e.g., 10 minutes). The electronic device 103 may identify that the local mode is not available in the electronic device 105 based on identifying from the information that the reception rate of the first data is less than the designated number for the designated time. For another example, the received signal may comprise the information for indicating whether a crash is caused while installing the one or more programs based on the first data. The electronic device 103 may identify that the local mode is not available in the electronic device 105 based on identifying that the crash is caused from the information. For another example, the received signal may comprise information for indicating whether a crash is caused while receiving the first data. The electronic device 103 may identify that the local mode is not available in the electronic device 105 based on identifying that the crash is caused while receiving the first data from the information. For another example, the received signal may comprise information for indicating whether a crash is caused while executing the one or more programs. The electronic device 103, based on identifying from the information that the crash occurs while executing the one or more programs, may identify that the local mode is not available in the electronic device 105. For another example, the received signal may comprise information for indicating whether the operation of the provided execution interface is ceased while executing the one or more programs. The electronic device 103 may identify that the local mode is not available in the electronic device 105 based on identifying from the information that the operation of the execution interface is ceased. For another example, the received signal may comprise information for indicating whether the state of the execution interface is a response state or an unresponsive state. The electronic device 103 may identify that the local mode is not available in the electronic device 105 based on identifying from the information that the state of the execution interface is the unresponsive state. For another example, the received signal may comprise the information for indicating whether a use of the frame less than the designated number or a change of the frame less than the designated number is detected while providing a tutorial interface of the game in the local mode. The electronic device 103 may identify that the local mode is not available in the electronic device 105 based on identifying that the use or the change of the frame less than the designated is detected from the information. For another example, the received signal may comprise the information indicating whether a crash is caused due to a lack of available space of the memory (e.g., the memory 404 or the memory 464) in the electronic device 105 while executing the game in the local mode. The electronic device 103 may identify that the local mode is not available in the electronic device 105 based on identifying from the information that the crash is caused due to a lack of available space in the memory. For another example, the received signal may comprise the information for indicating whether a phenomenon unrelated to a user input received while the game is being executed in the electronic device 105 in the local mode is caused. The electronic device 103 may identify that the local mode is not available in the electronic device 105 based on identifying that the phenomenon is caused from the information. However, it is not limited thereto.

In various embodiments, the electronic device 103 may identify that the local mode is not available in electronic device 105 through code in the signal obtained based on the API. For example, the code may be expressed as illustrated in Table 1.

TABLE 1

| CLASSIFICATION | CODE | TYPE OF ERROR |
|---|---|---|
| Installation Delay | A01 | Cease of the installation interface |
| | A02 | Non-response of the installation |
| | | interface (or installation display) |
| | A03 | Download or installation rate is |
| | | changed to less than 1% for 10 |
| | | minutes |
| Installation Error (Crash) | B01 | Installation ceasing due to the crash |
| | | of the application (and/or |
| | | installation file) |
| | B02 | Installation ceasing because |
| | | application (and/or installation file) |
| | | is not downloaded |
| | B03 | Installation ceasing because |
| | | application (and/or installation file) |
| | | is not executed |
| Execution Delay | C01 | Stop of the execution interface |
| | C02 | Non-response of the Execution |
| | | Interface (or execution display) |
| Performance deficit | D01 | Detection of operation less than the |
| | | designated fame while providing |
| | | tutorial |
| Execution Error (Crash) | E01 | Detection of crash due to the |
| | | deficiency of RAM |
| | E02 | Detection of error in cease, crash, |
| | | display due to unknown cause |

For example, the API may obtain data from the electronic device 105 for identifying codes expressed through Table 1 at the interval of designated period (e.g., 120 seconds). According to embodiments, when the obtained data corresponds to codes represented by Table 1, the API may obtain the signal and transmit the signal from the electronic device 105 to the electronic device 103. However, it is not limited thereto.

Although the description of operation 507 described above does not describe a case in which the first data is related to the update of the one or more programs, it is for convenience of explanation.

In operation 509, the electronic device 103 may transmit a signal to the electronic device 101 for instructing the electronic device 105 to provide the cloud mode based on identifying that the local mode is not available in the electronic device 105. In various embodiments, the signal may comprise information for specifying the electronic device 105 or a user of the electronic device 105. For example, the signal may comprise identification information of the electronic device 105 and/or identification information (or account information) of a user of the electronic device 105. Meanwhile, the electronic device 101 may receive the signal from the electronic device 103.

In operation 511, the electronic device 101 may execute at least one operation for granting authority to use the cloud mode to the electronic device 105 based on interworking with the electronic device 102. For example, the electronic device 101 may register information on the electronic device 105 and/or a user of the electronic device 105 in database for the cloud mode for granting authority to the specified electronic device 105 and/or a user of the specified electronic device 105 in the signal based on the information. However, it is not limited to this.

Although the operation 509 described above illustrates an example in which the electronic device 103 transmits the signal for instructing the electronic device 101 to provide the cloud mode to the electronic device 105, the signal may be transmitted to the electronic device 102. In this case, operation 511 may be executed via interworking between the electronic device 101 and the electronic device 102 based on the trigger of the electronic device 102.

Meanwhile, in operation 513, the electronic device 103 may transmit the second data for providing the cloud mode of the game to the electronic device 105 based on identifying that the local mode is not available in the electronic device 105. For example, the second data may be transmitted from the electronic device 103 to the electronic device 105 to access the electronic device 101 and/or the electronic device 102 for the cloud mode. For example, the second data may comprise information for accessing the electronic device 101 and/or the electronic device 102 for the cloud mode.

FIG. 5 illustrates an example of executing operation 513 after executing operation 509, but it is for convenience of explanation. According to embodiments, the electronic device 103 may execute operation 509 after executing operation 513 or may execute operation 509 and operation 513 simultaneously.

In addition, FIG. 5 illustrates an example in which the electronic device 103 does not receive information triggering (or initiating) transmission of the second data from the electronic device 101 and/or the electronic device 102 to the electronic device 105, but it is for convenience of explanation. According to embodiments, the electronic device 101 and/or the electronic device 102 may transmit a request to trigger (or initiate) to transmit the second data to the electronic device 105 after executing operation 511 and, under the condition that the electronic device 103 receives the request from the electronic device 101 and/or the electronic device 102, the electronic device 103 may transmit the second data to the electronic device 105.

In addition, FIG. 5 illustrates an example in which the electronic device 103 transmits the second data to the electronic device 105, but it is for convenience of explanation. According to embodiments, the second data may be transmitted from the electronic device 101 and/or the electronic device 102 to the electronic device 105 after executing operation 511. In this case, the electronic device 101 and/or the electronic device 102 that has transmitted the second data may transmit a signal for indicating that the second data is transmitted to the electronic device 150.

Meanwhile, the electronic device 105 may receive the second data from electronic device 103.

In operation 515, after receiving the second data, the electronic device 105 may transmit a request to access the electronic device 101 for the cloud mode.

For example, in response to receiving the second data from the electronic device 103, the electronic device 105 may display a message inquiring whether to execute the game through the cloud mode through the display of the electronic device 105. For example, the message may be a pop-up message or a push message. For another example, the message may be a notification message. For example, the message may be displayed through the display of the electronic device 105 based on the second data. For example, the message may comprise an executable object for accessing electronic device 101 for the cloud mode. For example, the executable object may be configured with a hyperlink including address information of the electronic device 101. However, it is not limited thereto.

The electronic device 105 may receive a user input for the message. The electronic device 105, in response to receiving the user input, may transmit the request to the electronic device 101. In various embodiments, the request may comprise data corresponding to information on the electronic device 105 and/or a user of the electronic device 105 registered through operation 511.

Meanwhile, the electronic device 101 may receive the request from the electronic device 105.

In operation 517, the electronic device 101 may authenticate the connection requested by the electronic device 105 based on at least a part of interworking with the electronic device 102 based on receiving the request. For example, the electronic device 101 may identify data included in the request. According to embodiments, the data may be identified based on interworking between the electronic device 101 and the electronic device 102. However, it is not limited to this.

In various embodiments, the electronic device 101 may authenticate the connection requested by electronic device 105 by identifying whether the identified data corresponds to the information on the electronic device 105 and/or a user of the electronic device 105 registered through operation 511. According to embodiments, authentication of the connection may be identified based on interworking between the electronic device 101 and the electronic device 102. However, it is not limited to this.

In operation 519, the electronic device 102, after completing the authentication through operation 517, may transmit at least one content of the game executed in the electronic device 102 to the electronic device 105 to play the game through the cloud game. For example, although not illustrated in FIG. 5, the electronic device 102 may receive a request from electronic device 105 to provide the game play through the cloud mode after completing the authentication through operation 517. For example, the request may be transmitted from the electronic device 105 to the electronic device 102 based on a user input on the executable object shown through the display of the electronic device 105. For example, the executable object may be comprised in the message shown through the display of the electronic device 105 based on the second data. In case that the execution object is included in the message, the execution object of the message may be activated after authentication is completed. For another example, the executable object may be a new icon on the cloud mode provided within a home screen shown through the display of electronic device 105 by providing electronic device 101 and/or electronic device 102 after authentication is completed. For example, a new icon may be provided in the electronic device 101 and/or the electronic device 102 to provide a user interface for cloud mode. For another example, the executable object may be a new executable object for cloud mode and is provided by electronic device 101 and/or electronic device 102 after authentication is completed and displayed within the user interface of pre-installed application 105. For example, the user interface of the application is the user interface of the web browser application, and the new execution object may be newly inserted into the favorite space of the commercial interface of the web browser application. However, it is not limited thereto.

Meanwhile, the electronic device 102 may transmit the at least one content to electronic device 105 in response to the request. The electronic device 105 may receive the at least one content from the electronic device 102.

In operation 521, the electronic device 105 may display the at least one content of the game executed in the electronic device 102 in response to reception of the at least one content in order to play the game through the cloud mode. For example, the at least one content may display the game execution screen 315 illustrated in FIG. 3. For example, the at least one content may be displayed in a user interface of a web browser application installed in the electronic device 105. For another example, the at least one content may be displayed in a user interface of an application installed in the electronic device 105 for the cloud mode. However, it is not limited thereto.

In various embodiments, the at least one content may comprise a visual object corresponding to a character for indicating a user of the electronic device 105 in the game. In various embodiments, the at least one content may comprise a visual object corresponding to a character for indicating a user of another client device (e.g., another client device 327) in the game. In various embodiments, the at least one content may comprise at least one executable object (e.g., executable object 317) for controlling the visual object corresponding to the character for indicating a user of the electronic device 105 in the game. The at least one executable object may be configured to receive a user input. However, it is not limited to this.

In operation 523, the electronic device 105 may transmit information on a user input received while displaying the at least one content to the electronic device 101. For example, referring to FIG. 3, the electronic device 105 may receive a user input 319 on executable object 317 while displaying the execution screen 315 of the game including the at least one content in the cloud mode. The electronic device 105 may transmit information on the user input 319 to the electronic device 101 in response to receiving the user input 319. Meanwhile, the electronic device 101 may receive the information on the user input 319 from the electronic device 105.

In operation 525, the electronic device 101 may transmit information on the user input 319 to the electronic device 102. For example, while playing in the cloud mode using the electronic device 105, since the execution subject of the game is the electronic device 102, not the electronic device 105, to reflect the information on the user input 319 on the game executed in the electronic device 102, the electronic device 101 may transmit the information on the user input 319 to the electronic device 102.

FIG. 5 illustrates an example in which the electronic device 105 transmits information on the user input from operation 523 to the electronic device 101 and transmits the information on the user input from operation 525 to the electronic device 102, but it is for convenience of explanation. Instead of transmitting the information to the electronic device 101, the electronic device 105 may transmit the information to the electronic device 102. In this case, the electronic device 101 may receive a signal from the electronic device 102 to indicate that the information is transmitted from the electronic device 105. For example, the electronic device 102 may transmit the signal to the electronic device 101 in response to receiving the information from the electronic device 105. However, it is not limited thereto.

Meanwhile, the electronic device 102 may receive the information on the user input 319 from the electronic device 101.

In operation 527, the electronic device 102 may transmit a signal for changing at least some of the at least one content shown through the display of the electronic device 105 to the electronic device 105, based on the information on the user input 319 received from the electronic device 101. For example, the electronic device 102 may obtain a signal for changing at least some of the at least one content shown through the display of the electronic device 105 by changing the state of the game executed for the cloud mode of the electronic device 105 in the electronic device 102. The electronic device 102 may transmit the obtained signal to the electronic device 105.

Meanwhile, the electronic device 105 may receive the signal from electronic device 102. Although not illustrated in FIG. 5, the electronic device 105 may change at least some of the at least one content shown through the display of the electronic device 105 based on the signal.

As described above, the electronic device 103 and the electronic device 105 according to various embodiments may provide a service for playing the game through the cloud mode based on interworking with the electronic device 101 and/or the electronic device 102 when the local mode of the game is not available in the electronic device 105. In other words, the electronic device 103 and the electronic device 105 according to various embodiments may maintain continuity of the game by providing a service for playing the game through the cloud mode based on interworking with the electronic device 101 and/or the electronic device 102 even though the local mode of the game is not available.

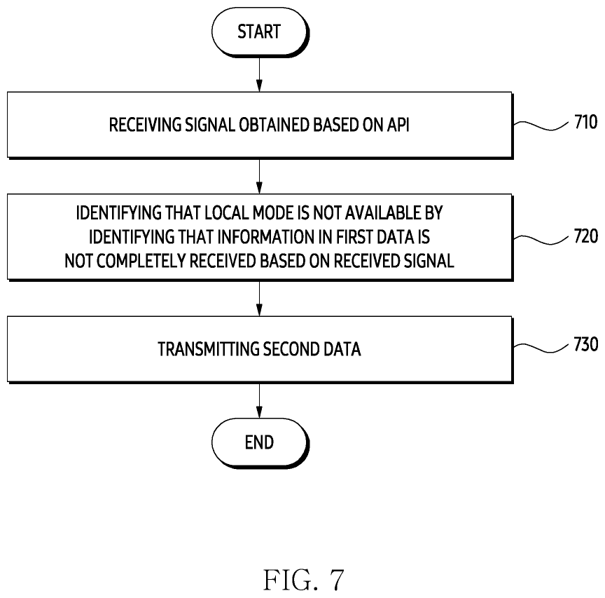

FIG. 7, according to various embodiments, is a flowchart illustrating a method of transmitting the second data based on partial reception of the first data. This method may be executed by at least one processor of the electronic device 103 or the electronic device 103 illustrated in FIGS. 1, 4, and 5.

Operations 710 to 730 of FIG. 7 may be related to operations 505, 507, and 513 of FIG. 5.

Referring to FIG. 7, in operation 710, the electronic device 103 may receive the signal obtained based on the API comprised in the first data from the electronic device 105.

In operation 720, the electronic device 103, by identifying that the information in the first data for installing the game for the local mode is not fully received from the electronic device 104, based on the received signal, may identify that the local mode is not available in the electronic device 105. For example, electronic device 103 may identify that code A03 and/or B02 of Table 1 is comprised in the signal, based on identifying that the information in the first data is not completely received and may identify that the local mode is not available in the electronic device 105.

In operation 730, based on identifying that the local mode is not available in electronic device 105, the electronic device 103 may transmit the second data to the electronic device 105. For example, the electronic device 103 may transmit the second data to the electronic device 105 so that a user of the electronic device 105 may play the game through the cloud mode while the local mode is not available in the electronic device 105. For example, the second data may be transmitted from the electronic device 103 to the electronic device 105 to provide a space for playing the game to a user of the electronic device 105 until the state of the electronic device 105 is changed to a state capable of playing the game through the local mode. However, it is not limited thereto.

As described above, the electronic device 103 according to various embodiments may transmit the second data to the electronic device 105 while the local mode is not available in the electronic device 105 because the electronic device 105 does not completely receive the installation data (e.g. the information in the first data) for the local mode of the game from the electronic device 104. The electronic device 103 according to various embodiments may provide the cloud mode to the electronic device 105 through transmission of the second data so that the user of the electronic device 105 may play the game in the cloud mode even if the installation data is not completely received. In other words, the electronic device 103 according to various embodiments may enhance the user's convenience of the game by providing persistence of the game through transmission of the second data.

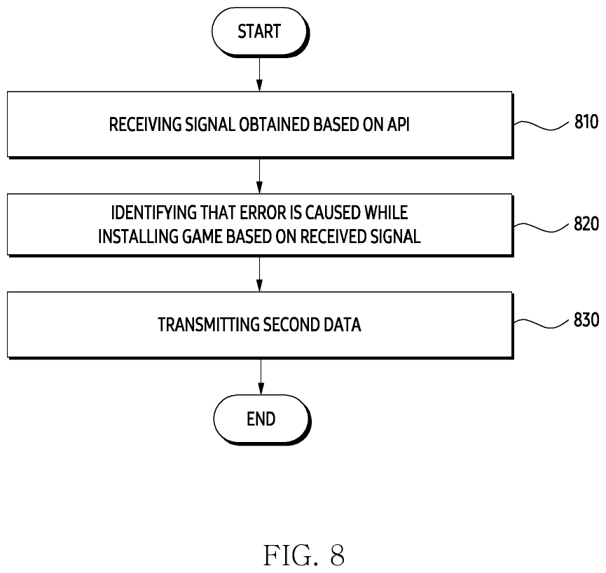

FIG. 8 is a flowchart illustrating a method of transmitting the second data based on an error during game installation according to various embodiments. This method may be executed by the processor of the electronic device 103 or the electronic device 103 illustrated in FIGS. 1, 4, and 5.

Operations 810 to 830 of FIG. 8 may be related to operations 505, 507, and 513 of FIG. 5.

Referring to FIG. 8, in operation 810, the electronic device 103 may receive the signal obtained based on the API included in the first data from the electronic device 105.

In operation 820, the electronic device 103 may identify that an error is caused while installing the game for the local mode (or installing the one or more programs for playing the game), based on the received signal. For example, the error may comprise at least one of a crash, a hang, or a freeze. However, it is not limited thereto. For example, by identifying that codes A01, A02, B01, B02, and/or B03 of Table 1 are comprised in the signal, the electronic device 103 may identify that the error is caused while installing the game for the local mode. The electronic device 103 may identify that the local mode is not available in the electronic device 105 based on identifying that the error is caused while installing the game for the local mode.

In operation 830, the electronic device 103 may transmit the second data to the electronic device 105 based on identifying that the local mode is not available in the electronic device 105. For example, the electronic device 103 may transmit the second data to the electronic device 105 so that the user of the electronic device 105 may play the game through the cloud mode while the local mode is not available in the electronic device 105. For example, the second data may be transmitted from the electronic device 103 to the electronic device 105 to provide a space for playing the game to a user of the electronic device 105 until the state of the electronic device 105 is changed to a state capable of playing the game through the local mode. However, it is not limited to this.

As described above, the electronic device 103, according to various embodiments, may transmit the second data to the electronic device 105 while the electronic device 105 may not install the game for the local mode due to the error. The electronic device 103, according to various embodiments, may provide the cloud mode to the electronic device 105 through transmission of the second data so that the user of the electronic device 105 may play the game in the cloud mode even if the electronic device 105 may not install the game for the local mode. In other words, the electronic device 103, according to various embodiments, may enhance the user's convenience of the game by providing persistence of the game through transmission of the second data.

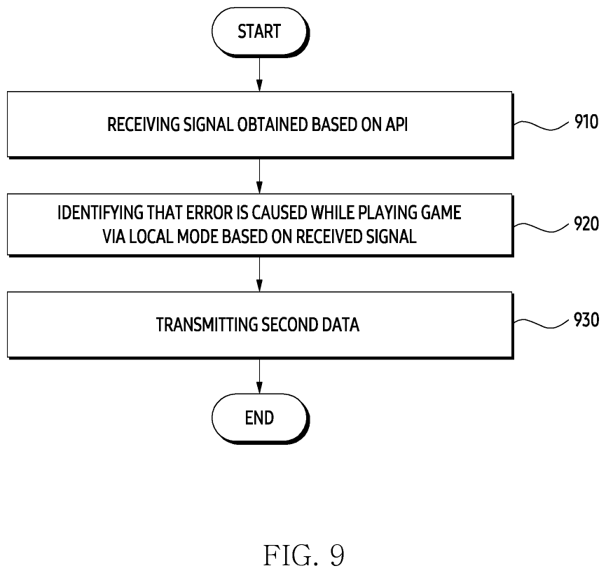

FIG. 9 is a flowchart illustrating a method of transmitting the second data based on an error while executing the game in the local mode according to various embodiments. This method may be executed by the processor of the electronic device 103 or the electronic device 103 illustrated in FIGS. 1, 4, and 5.

Operations 910 to 930 of FIG. 9 may be related to operations 505, 507, and 513 of FIG. 5.

Referring to FIG. 9, in operation 910, the electronic device 103 may receive the signal obtained based on the API comprised in the first data from the electronic device 105.

In operation 920, the electronic device 103 may identify that an error is caused while playing the game in the electronic device 105 through the local mode based on the received signal. For example, the error may comprise at least one of a crash, a hang, or a freeze. However, it is not limited to this. For example, by identifying that codes C01, C02, D01, E01, and/or E02 of Table 1 are comprised in the signal, the electronic device 103 may identify that the error is caused while the game is being executed in the electronic device 105 through the local mode. The electronic device 103 may identify that the local mode is not available in the electronic device 105 based on identifying that the error is caused while the game is being executed in the electronic device 105 through the local mode.

In operation 930, the electronic device 103 may transmit the second data to the electronic device 105 based on identifying that the local mode is not available in the electronic device 105. For example, the electronic device 103 may transmit the second data to the electronic device 105 so that the user of the electronic device 105 may play the game through the cloud mode while the local mode is not available in the electronic device 105. For example, the second data may be transmitted from the electronic device 103 to the electronic device 105 to provide a space for playing the game to a user of the electronic device 105 until the state of the electronic device 105 is changed to a state capable of playing the game through the local mode. However, it is not limited thereto.

As described above, the electronic device 103, according to various embodiments, may transmit the second data to the electronic device 105 while the electronic device 105 may not execute the game through the local mode due to the error. According to various embodiments, the electronic device 103 may provide the cloud mode to the electronic device 105 through transmission of the second data so that the user of the electronic device 105 may play the game in the cloud mode even if the electronic device 105 may not execute the game through the local mode. In other words, according to various embodiments, the electronic device 103 may enhance the user's convenience of the game by providing persistence of the game through transmission of the second data.

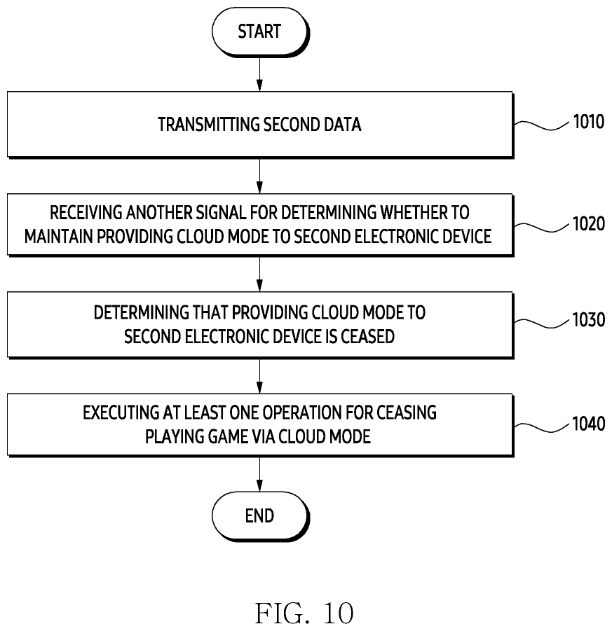

FIG. 10 is a flowchart illustrating a method of determining to cease providing the cloud mode according to various embodiments. This method may be executed by the processor of the electronic device 103 or the electronic device 103 illustrated in FIGS. 1, 4, and 5.

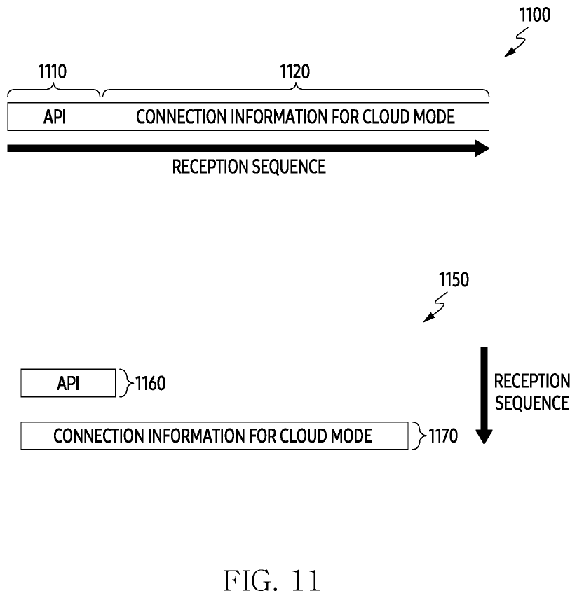

FIG. 11 illustrates examples of the second data received to an electronic device according to various embodiments.

Referring to FIG. 10, in operation 1010, the electronic device 103 may transmit the second data to the electronic device 105. For example, operation 1010 may correspond to operation 513 of FIG. 5.

In operation 1020, after transmitting the second data to the electronic device 105, the electronic device 103 may receive another signal for determining whether to maintain providing the cloud mode to the electronic device 105. For example, in operation 505, another signal may be distinguished from the signal transmitted from the electronic device 105 to the electronic device 103.

In various embodiments, another signal may be obtained by the electronic device 105 based on an application programming interface (API) for identifying whether to maintain providing the cloud mode to the electronic device 105. For example, the API may be transmitted from the electronic device 103 to the electronic device 105 before playing the game in the electronic device 105 through the cloud mode. For example, the electronic device 103 may transmit the second data comprising the API to the electronic device 105. For example, referring to FIG. 11, the second data may be configured with format 1100. For example, the second data may be configured as a single packet and comprise the API 1110 for identifying whether to maintain providing the cloud mode to the electronic device 105 and connection information 1120 for the cloud mode. The second data configured as the one packet may be configured such that the electronic device 105 receives the connection information 1120 after receiving the API 1110 from the electronic device 103. For example, API 1110 may be configured to be robust to noise. For example, the API 1110 received in the electronic device 105 may be configured to monitor whether the connection information 1120 is used for the cloud mode by being received by the electronic device 105 prior to the connection information 1120. For another example, referring to FIG. 11, the second data may be configured with format 1150. For example, the second data may be configured as a plurality of packets. For example, the plurality of packets may comprise a packet 1160 comprising an API for determining whether to maintain providing the cloud mode to the electronic device 105 and may comprise a packet 1170 comprising access information for the cloud mode. The packet 1160 may be configured such that the electronic device 105 receives the packet 1170 after receiving the packet 1150 from the electronic device 103. For example, the packet 1160 may be configured to be robust to noise. For example, the packet 1160 received in the electronic device 105 may be received by the electronic device 105 prior to the packet 1170, thereby monitoring whether the access information in the packet 1170 is used for the cloud mode.

For another example, the electronic device 103 may transmit the second data to the electronic device 105 and then transmit the API to the electronic device 105. For another example, the electronic device 103 may receive a signal for instructing that the authentication is completed from at least one of the electronic device 101 or the electronic device 102 after the authentication executed in operation 517 is completed and, in response to the reception of the signal for instructing that the authentication is completed, may transmit the API to the electronic device 105. For another example, the electronic device 103 may receive a signal for instructing the request from the electronic device 105 from the electronic device 102 receiving the request that the play of the game is provided through the cloud mode from the electronic device 105 after the authentication is completed through operation 517, and, in response to the reception of the signal for instructing the request, may transmit the API to the electronic device 105 before the cloud mode is provided to the electronic device 105. However, it is not limited thereto.

In operation 1030, the electronic device 103 may determine to cease providing the cloud mode to the electronic device 105 based on another signal. For example, the electronic device 103 may identify at least one code configured similarly to Table 1 in another signal and determine to cease providing the cloud mode to the electronic device 105 based on the identification of the at least one code.

In operation 1040, the electronic device 103 may execute at least one operation for ceasing playing the game on the electronic device 105 through the cloud mode based on the determination. For example, the electronic device 103, based on the determination, may execute at least one operation by depriving, revoking, or retracting the authority to use the cloud mode from the electronic device 105 (or a user of the electronic device 105) through signaling with the electronic the electronic device 101 and/or the electronic device 102. For another example, the electronic device 103 may execute at least one operation by deactivating an executable element (e.g., the new icon, the new executable object, etc.) inserted into the electronic device 105 to provide the cloud mode through a connection between the electronic device 103 and the electronic device 105 based on the determination. However, it is not limited thereto.

As described above, the electronic device 103, according to various embodiments, may identify that ceasing the cloud mode is demanded provided to the electronic device 105 while providing the local mode by receiving another signal obtained based on the API from the electronic device 105. According to various embodiments, the electronic device 103, through this identification, may cease providing the cloud mode to electronic device 105, thereby enhancing the efficiency of resources related to the cloud mode. For example, when the local mode is available in the electronic device 105, the electronic device 103 may cease providing the cloud mode based on the another signal obtained based on the API and received from the electronic device 105 and enhance the efficiency of the resource related to the cloud mode by using the obtained resource according to the cease for the cloud mode provided to the another device distinguished from the electronic device 105. For another example, when the cloud mode is not used in the electronic device 105 despite the provision of the cloud mode, the electronic device 103 may cease providing the cloud mode based on the signal obtained based on the API and received from the electronic device 104 and enhance the efficiency of the resource related to the cloud mode by the resource obtained according to the sea for the cloud mode provided to the another device distinguished from the electronic device 105.

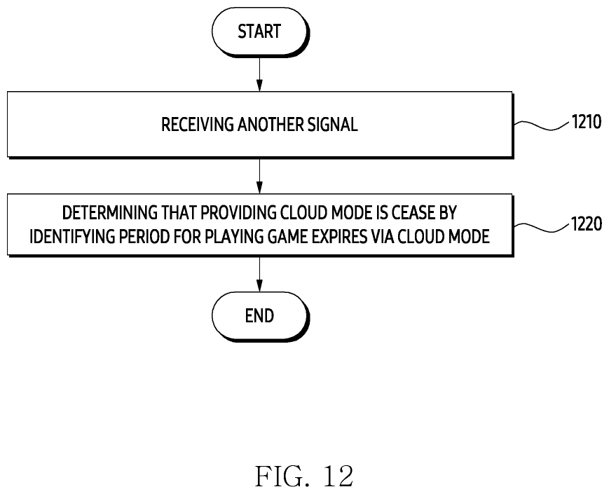

FIG. 12 is a flowchart illustrating a method of determining to cease providing the cloud mode based on expiration of a period in which a game may be played through the cloud mode, according to various embodiments. This method may be executed by at least one processor of the electronic device 103 or the electronic device 103 illustrated in FIGS. 1, 4, and 5.

Operations 1210 to 1220 of FIG. 12 may be related to operations 1020 to 1030 of FIG. 10.

Referring to FIG. 12, in operation 1210, the electronic device 103 may receive another signal. For example, operation 1210 may correspond to operation 1020 of FIG. 10.

In operation 1220, the electronic device 103 may cease providing the cloud mode by identifying that a period during which the game may be played through the cloud mode is expired based on another signal. For example, the API defined through the description of FIGS. 10 and/or 11 may comprise a timer. In various embodiments, the timer may be activated within the electronic device 105 from a designated timing. For example, the designated timing may be a timing in which the API is comprised in the electronic device 105. For another example, the designated timing may be a timing for initiating the cloud mode in the electronic device 105. However, it is not limited thereto. In various embodiments, the API identify the expiration of the period using the timer, obtain the other signal in the electronic device 105 based on identifying the expiration of the period, and transmit the obtained other signal from the electronic device 105 to the electronic device 103. Meanwhile, the electronic device 103 may cease providing the cloud mode by receiving another signal obtained based on the API from the electronic device 105 and identifying that a period for playing the game through the cloud mode has expired based on another signal.

As described above, according to various embodiments, the electronic device 103 may identify that a period for playing the game through the cloud mode expires using the API provided from the electronic device 103 to the electronic device 105. Through this identification, the electronic device 103 according to various embodiments may cease providing the cloud mode to electronic device 105, thereby enhancing the efficiency of resources related to the cloud mode. For example, when the period for playing the game in the electronic device 105 expires through the cloud mode, the electronic device 103 may cease providing the cloud mode based on the signal obtained the another signal from the electronic device 105 obtained based on the API and may enhance the efficiency of the resource related to the cloud mode by using the resource obtained according to the cease to another electronic device distinguished from the electronic device 105.

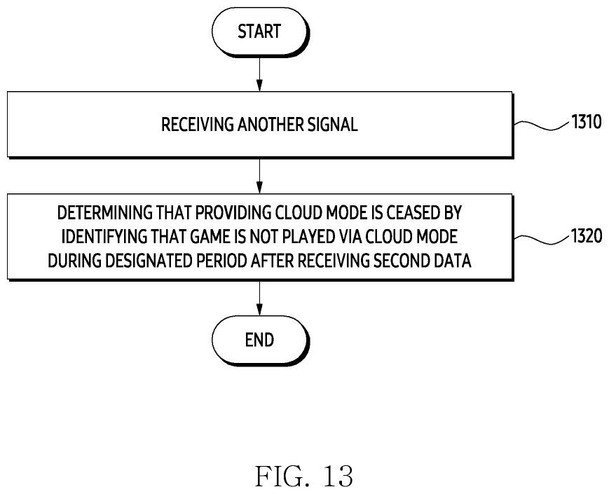

FIG. 13 is a flowchart illustrating a method of determining to cease providing the cloud mode based on identifying that the game is not played for a designated period through the cloud mode, according to various embodiments. This method may be executed by at least one processor of the electronic device 103 or the electronic device 103 illustrated in FIGS. 1, 4, and 5.

Operations 1310 to 1320 of FIG. 13 may be related to operations 1020 to 1030 of FIG. 10.

Referring to FIG. 13, in operation 1310, the electronic device 103 may receive another signal. For example, operation 1310 may correspond to operation 1020 of FIG. 10.

In operation 1320, the electronic device 103 may determine to cease providing the cloud mode to the electronic device 105 by identifying that the game is not played through the cloud mode for the designated period after receiving the second data based on another signal. For example, the designated period may be a parameter for identifying whether playing the game through the cloud mode is preferred by the user of the electronic device 105. For example, not playing the game in the electronic device 105 through the cloud mode for the designated period after receiving the second data may mean that the user of the electronic device 105 does not prefer to play the game through the cloud mode. For example, the API defined through the description of FIGS. 10 and/or 11 may comprise data for monitoring whether the game is played in the electronic device 105 through the cloud mode for a designated period after receiving the second data. In various embodiments, the API may identify that the game is not played in the electronic device 105 through the cloud mode for a designated period after receiving the second data using the data, obtain another signal in the electronic device 105 based on the identification, and transmit the obtained signal to the electronic device 103. Meanwhile, the electronic device 103 may receive another signal obtained based on the API from the electronic device 105 and may cease providing the cloud mode by identifying that the game is not played through the cloud mode during the designated period after receiving the second data based on another signal.

FIG. 13 illustrates an example of identifying whether the game is played through the cloud mode for the designated time after receiving the second data, but this is for convenience of explanation. It should be noted that the start timing of the designated time may be changed according to embodiments. For example, the API may be configured to set the most recently terminated timing of playing the game in the electronic device 105 through the cloud mode as the start timing of the designated timing instead of the reception timing of the second data. In this case, in operation 1320, the electronic device 103 may cease providing the cloud mode to the electronic device 105 by identifying that the game is not played through the cloud mode during the designated period from the most recently terminated timing.

As described above, the electronic device 103, according to various embodiments, may identify that the game is not played through the cloud mode using the API provided from the electronic device 103 to the electronic device 105. Through this identification, the electronic device 103 according to various embodiments may cease providing the cloud mode to electronic device 105, thereby enhancing the efficiency of resources related to the cloud mode. For example, when the game is not executed for the designated period in the electronic device 105 through the cloud mode, the electronic device 103 may cease providing the cloud mode based on the another signal received from the electronic device 105 obtained based on the API and enhance the efficiency of the resource related to the cloud mode by using the resource obtained according to the cease for the cloud mode provided to the another electronic device distinguished from the electronic device 105.

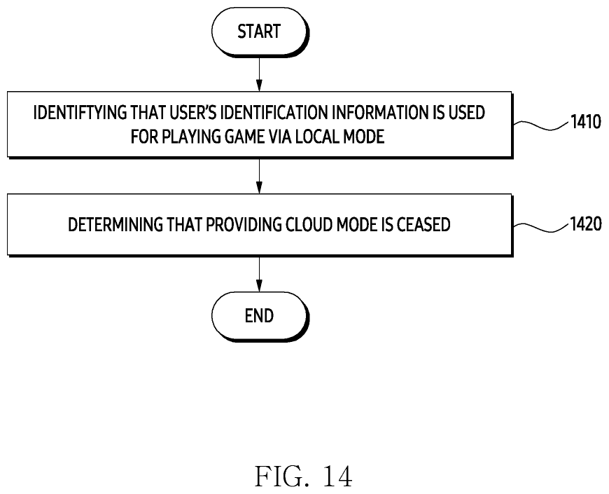

FIG. 14 is a flowchart illustrating a method of determining to cease providing the cloud mode based on identifying that playing the game through the local mode is activated in another electronic device according to various embodiments. This method may be executed by at least one processor of the electronic device 103 or the electronic device 103 shown in FIGS. 1, 4, and 5.

Referring to FIG. 14, after transmitting the second data to the electronic device 105, the electronic device 103 may identify that the identification information of the user of the electronic device 105 is used to play the game through the local mode within another electronic device 105 distinguished from the electronic device 105. For example, after transmitting the second data, the electronic device 103 may transmit a notify request to the electronic device 101 to notify whether the identification information (e.g., account information) of the user of the electronic device 105 is used to play the game through the local mode. In response to the request, the electronic device 103 may identify that the identification information is used to play the game through the local mode in another electronic device based on receiving a response to indicate that the game is used through the local mode in another electronic device from the electronic device 101.

In operation 1420, the electronic device 103 may determine to cease providing the cloud mode based on the identification. For example, since that the identification information used to play the game through the local mode in the other electronic device means that the user of the electronic device 105 may play the game in the local mode using another electronic device even if the cloud mode is not used, electronic device 103 may determine to cease providing the cloud mode.

As described above, the electronic device 103 according to various embodiments may transmit the second data to the electronic device 105, and then identify that the identification information of the user of the electronic device 105 is used to play the game through the local mode in another electronic device. Through this identification, the electronic device 103 according to various embodiments may cease providing the cloud mode to the electronic device 105, thereby enhancing the efficiency of resource related to the cloud mode. For example, when the user of the electronic device 105 may play the game in the local mode through another means while the local mode is not available in the electronic device 105, the electronic device 103 may cease providing the cloud mode and enhance the efficiency of the resource related to the cloud mode by using the resource obtained according to the cease for the cloud mode provided to the another electronic device distinguished from the electronic device 105.

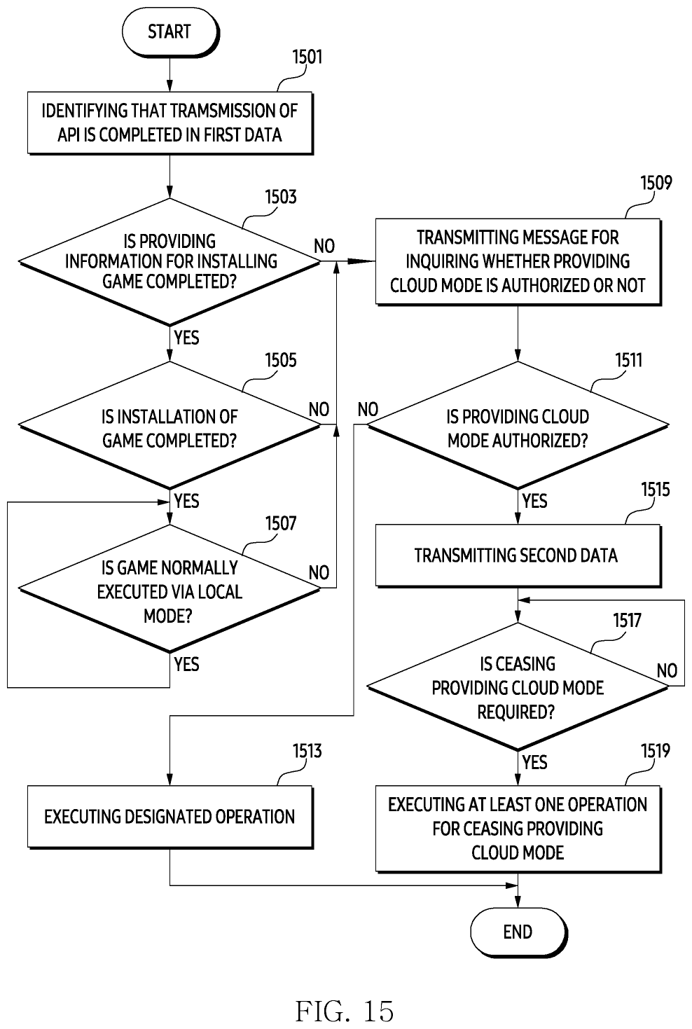

FIG. 15 is a flowchart illustrating a method of providing the cloud mode according to various embodiments. This method may be executed by at least one processor of the electronic device 103 or the electronic device 103 illustrated in FIGS. 1, 4, and 5.

Referring to FIG. 15, in operation 1501, the electronic device 103 may identify that transmission of the API in the first data is completed to the electronic device 105. For example, the identification may be executed based on interworking between the electronic device 103 and the electronic device 104. For another example, the identification may be executed based on an interaction between the electronic device 103 and the electronic device 105 receiving the API. However, it is not limited thereto.

In operation 1503, the electronic device 103 may identify whether providing information for installation of the game through the local mode to the electronic device 105 is completed based on the identification. For example, identifying whether providing information for installation of the game through the local mode to the electronic device 105 is completed may be executed based on the information in the signal (e.g., the signal defined through the description of operation 505 of FIG. 5) transmitted from the electronic device 105 based on the API comprised in the electronic device 105. When providing information for installing the game to the electronic device 105 through the local mode is completed, the electronic device 103 may execute operation 1505, otherwise execute operation 1509.

In operation 1505, the electronic device 103 may identify whether the installation of the game through the local mode is completed based on identifying that providing the information for installation of the game through the local mode to the electronic device is completed. For example, identifying whether the installation of the game through the local mode is completed may be executed based on the information in the signal transmitted from the electronic device 105 based on the API comprised in the electronic device 105. When the installation of the game through the local mode is completed, the electronic device 103 may execute operation 1507, otherwise execute operation 1509.

In operation 1507, the electronic device 103 may identify whether the game is successfully executed through the local mode based on identifying that the installation of the game is completed through the local mode. For example, identifying whether the game is normally executed through the local mode may be executed based on the information in the signal transmitted from the electronic device 105 based on the API comprised in the electronic device 105. When the game is normally executed through the local mode, the electronic device 103 may continuously execute operation 1507, otherwise execute operation 1509.

In operation 1509, the electronic device 103 may send a message to the electronic device 105 to inquire whether the game is authorized to provide the cloud mode based on identifying that providing the information for the installation of the game through the local mode is not completed, that installation of the game is not successfully completed, or that the game is not successfully executed through the local mode. For example, the message received by the electronic device 105 may be shown through the display of the electronic device 105.

In operation 1511, the electronic device 103 may identify whether providing the cloud mode to electronic device 105 after transmitting the message is authorized by the user of electronic device 105. For example, after transmitting the message, the electronic device 103 may identify whether providing the cloud mode to the electronic device 105 is authorized by the user of the electronic device 105 by identifying whether receiving information on a user input for the message shown through the display of electronic device 105. For example, when the information on the user input for the message indicates that the information on the user input for the message is authorized to provide the cloud mode to the electronic device 105, the electronic device 103 may identify that providing the cloud mode to the electronic device 105 is authorized. For another example, when the information on the user input for the message indicates that providing the cloud mode to the electronic device 105 is not authorized, the electronic device 103 may identify that providing the cloud mode to the electronic device 105 is not authorized. For another example, when information on the user input for the message is not received by the electronic device 103 for a designated time, the electronic device 1030 may identify that providing the cloud mode to the electronic device 105 is not authorized. For example, the designated period may be a parameter for identifying whether the user of the electronic device 105 is interested in the cloud mode. In other words, the designated period may be a parameter defined in consideration that the user is not interested in the cloud mode when the user of the electronic device 105 does not cause the user input for the designated period. However, it is not limited thereto.

In various embodiments, the electronic device 103 may only execute operation 1511 when providing the cloud mode to electronic device 105 is authorized by the user of electronic device 105, otherwise execute operation 1513.

In operation 1513, the electronic device 103 may execute a designated operation based on identifying that providing the cloud mode to the electronic device 105 is not authorized. For example, the designated operation may be an operation of the electronic device 103 executed as the cloud mode is not used for the electronic device 105. For example, the electronic device 103 may execute transmitting a message requesting to set the priority of recovery of the local mode to the device 105, which is higher to a plurality of priorities of the local mode for another electronic device authorized to provide the cloud mode, as the designated operation. For example, the message may be displayed through the display of the device. For another example, the message may be used to adjust the priority of recovery of the local mode for the electronic device 105 and a plurality of priorities of the local mode for the other electronic device without user input within the device. However, it is not limited thereto.

In operation 1515, the electronic device 103 may transmit the second data to the electronic device 105 based on identifying that it is authorized to provide the cloud mode to the electronic device 105.

In operation 1517, the electronic device 103 may identify whether to cease providing the cloud mode to the electronic device 105 after transmitting the second data is required. When to cease providing the cloud mode to the electronic device 105 is required, the electronic device 103 may execute operation 1519, otherwise may continuously execute operation 1517.

In operation 1519, the electronic device 103 may execute at least one operation for ceasing providing the cloud mode based on identifying that to cease providing the cloud mode to the electronic device 105 is required.

As described above, the electronic device 103 according to various embodiments may provide the cloud mode so that the user of the electronic device 105 is not disconnected from playing the game while recovering the local mode to the electronic device 105 through the operations of FIG. 15. The electronic device 103 according to various embodiments may enhance the efficiency of the resource of the cloud mode by monitoring whether to cease providing the cloud mode while providing the cloud mode to the electronic device 105 is required.

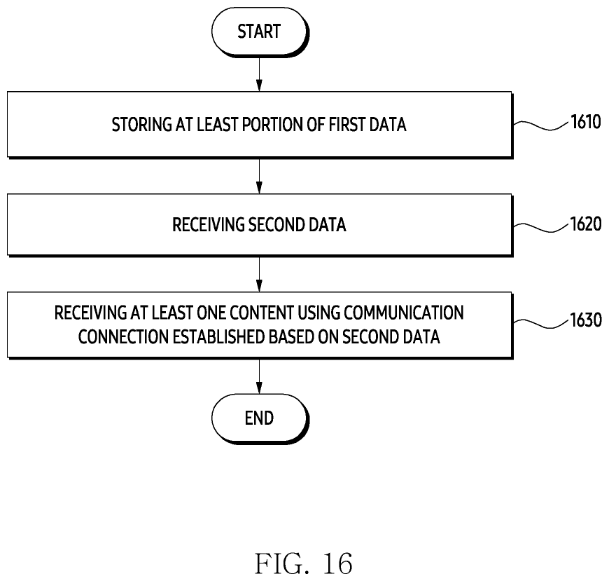

FIG. 16 is, according to various embodiments, a flowchart illustrating a method of executing the game through the cloud mode while the local mode is not available. This method may be executed by at least one processor of the electronic device 105 or the electronic device 105 illustrated in FIGS. 1 to 5.

Referring to FIG. 16, in operation 1610, the electronic device 105 may store at least a portion of the first data in at least one memory of the electronic device 105. For example, the electronic device 105 may store all of the first data in the at least one memory by receiving both the API in the first data and the information in the first data. For another example, the electronic device 105 may store a portion of the first data in the at least one memory by receiving the API in the first data and not receiving at least a portion of the information in the first data.

In operation 1620, the electronic device 105 may receive the second data from the electronic device 103 while the local mode is not available in the electronic device 105. For example, the electronic device 105 may receive the second data from the electronic device 103 while the local mode is not available in the electronic device 105 by at least one of not fully receiving the first data, not successfully installing the game based on the first data for the local mode, or not successfully executing the installed game.

In operation 1630, the electronic device 105 may display the at least one content received from the electronic device 102 using a communication connection between the electronic device 102 and the electronic device 105, established based on the second data, for the play of the game through cloud mode.

As described above, the electronic device 105, according to various embodiments, may establish a communication connection between the electronic device 102 and the electronic device 105 using the second data received from the electronic device 103 while the local mode is not available in the electronic device 105. The electronic device 105, according to various embodiments, may receive the at least one content from the electronic device 102 using the communication connection so as to play the game through the cloud mode and display the received at least one content. In other words, the electronic device 105 according to various embodiments may enhance the usability of the game by providing a service using the cloud mode under the condition that the local mode is not available.

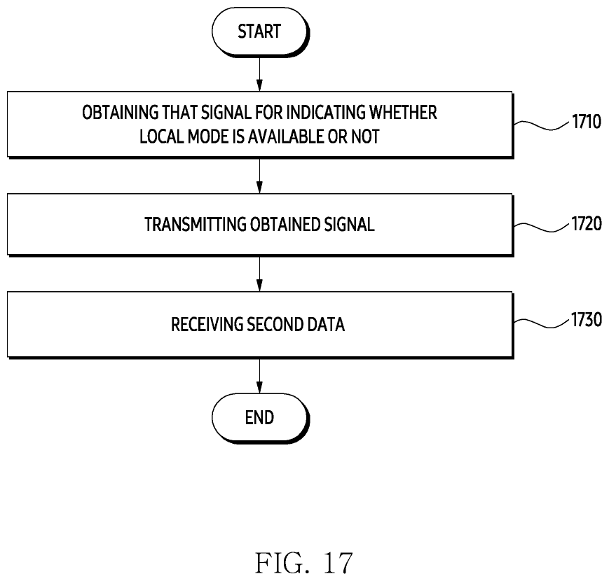

FIG. 17 is a flowchart illustrating a method of receiving the second data according to various embodiments. This method may be executed by at least one processor of the electronic device 105 or the electronic device 105 illustrated in FIGS. 1 to 5.

Operations 1710 to 1730 of FIG. 17 may be related to operation 1620 of FIG. 16.

Referring to FIG. 17, in operation 1710, the electronic device 105 may obtain a signal for indicating whether the local mode is available. For example, the electronic device 105 may obtain the signal comprising information for indicating whether information is successfully downloaded from the electronic device 104 in relation to the local mode using the API obtained from the electronic device 101, the electronic device 102, or the electronic device 103. For another example, the electronic device 105 may obtain the signal comprising information for indicating whether the information downloaded from electronic device 104 in relation to the local mode is successfully installed using the API. As another example, the electronic device 105 may obtain the signal comprising information for indicating whether the installed information is successfully executed in relation to the local mode using the API. However, it is not limited thereto.

In operation 1720, the electronic device 105 may transmit the obtained signal to the electronic device 103. For example, the signal may be transmitted based on the API.

In operation 1730, after transmitting the signal, the electronic device 105 may receive the second data from the electronic device 103.

As described above, the electronic device 105, according to various embodiments, may enhance usability of the game by obtaining a signal for identifying whether the local mode is available in the electronic device 105 using the API obtained from the electronic device 101, the electronic device 102, or 103.

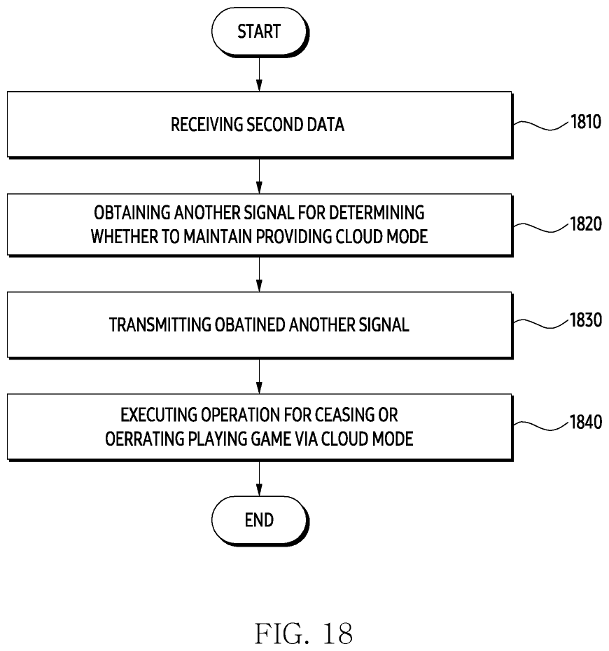

FIG. 18 is a flowchart illustrating a method of maintaining or ceasing playing the game through the cloud mode, according to various embodiments. This method may be executed by at least one processor of the electronic device 105 or the electronic device 105 illustrated in FIGS. 1 to 5.

Operations 1810 to 1840 of FIG. 18 may be related to operation 1620 of FIG. 16.

Referring to FIG. 18, in operation 1810, the electronic device 105 may receive the second data. For example, the second data may comprise the API for identifying whether to maintain the cloud mode provided in the electronic device 105.

In operation 1820, the electronic device 105 may obtain another signal for determining whether to maintain the cloud mode provided by the electronic device 105 obtained based on the API in the second data after receiving the second data. For example, the electronic device 105 may obtain the another signal comprising at least one of information indicating whether the period of providing the cloud mode in the electronic device 105 expires, information indicating whether the cloud mode is not used in the electronic device 105, information indicating whether the frequency of using the cloud mode in the electronic device 105 is less than a reference frequency, or information indicating whether the state of the electronic device 105 is changed to the state that supports the local mode. However, it is not limited thereto.

In operation 1830, the electronic device 105 may transmit the obtained another signal to the electronic device 103.

In operation 1840, the electronic device 105 may execute an operation for maintaining or ceasing playing the game in the electronic device 105 through the cloud mode according to a determination executed in the electronic device 103 based on another signal. For example, the electronic device 103 may determine whether to cease providing the cloud mode to the electronic device 105 based on another signal received from the electronic device 105. For example, the electronic device 103 may transmit a signal to the electronic device 105 to notify the electronic device 105 that the cloud mode is maintained to be provided to the electronic device 105, based on determining that the cloud mode is maintained to be provided to the electronic device 105. The electronic device 105 may maintain the elements related to the cloud mode comprised (or stored, installed) in the electronic device 105 based on the signal received from the electronic device 103, thereby maintaining playing the game in the electronic device 105 through the cloud mode. As another example, the electronic device 103 may transmit a signal for deactivating the cloud mode in the electronic device 105 based on determining that the cloud mode is ceased to provide the cloud mode to the electronic device 105. The electronic device 105 may deactivate the elements related to the cloud mode comprised in the electronic device 105 based on the signal received from the electronic device 103, and thus may cease playing the game in the electronic device 105 through the cloud mode.

As described above, the electronic device 105, according to various embodiments, may perform operations for determining whether to maintain the cloud mode, thereby enhancing the efficiency of resource according to the use of the cloud mode. For example, when both the cloud mode and the local mode are available in the electronic device 105, the electronic device 105 may cease playing the game through the cloud mode, thereby preventing unnecessary resource from being allocated for the cloud mode.

Methods according to the embodiments described in the claims or specifications of the present disclosure may be implemented in the form of hardware, software, or a combination of hardware and software.

When implemented as software, a computer-readable storage medium may be provided that stores one or more programs (software modules). One or more programs stored in a computer-readable storage medium are configured for execution by one or more processors in an electronic device. One or more programs comprise instructions that cause the electronic device to execute methods according to the embodiments described in the claims or specification of the present disclosure.

One or more of these programs (software modules, software) may be stored in a memory configured as non-volatile memory comprising random access memory and flash memory, Read Only Memory (ROM), Electrically Erasable Programmable Read Only Memory (EEPROM), magnetic disc storage device, optical storage device (e.g., CD-ROM: Compact Disc-Rom), DVD: Digital Versatile Discs), magnetic cassettes, or a combination thereof. Alternatively, it may be stored in a memory composed of a combination of some or all of them. In addition, the program may be stored in an attachable storage device that may be accessed through a communication network such as Internet, Intranet, Local Area Network (LAN), Wide LAN (WLAN), Storage Area Network (SAN), or a combination thereof. Such a storage device may access a device performing an embodiment of the present disclosure through an external port. In addition, a separate storage device on the communication network may access a device performing an embodiment of the present disclosure.

In specific embodiments of the present disclosure described above, components of the electronic device comprised in the present disclosure have been expressed in single or plural according to the specific embodiments presented. However, singular or plural expressions for the above components are appropriately selected for the situation for the convenience of explanation, and the present disclosure is not limited to singular or plural components. Therefore, components expressed in plural may be configured as single and components expressed in single may be configured as plural.

Meanwhile, the detailed embodiments have been described in the detailed description of the present disclosure, but it goes without saying that various modifications can be made within the limit not departing from the scope of the present disclosure. Therefore, the scope of the present disclosure should not be limited to the described embodiments but should be determined by the scope of the claim to be described later as well as those equivalent to the scope of the claim.

What is claimed is:

1. A non-transitory computer readable storage medium storing one or more programs, the one or more programs comprising instructions which, when executed by at least one processor of a first electronic device with a communication circuit, cause the first electronic device to:
receive, via the communication circuit from a second electronic device that has received at least portion of first data for an execution of a game, a signal for indicating that a local mode is not available in the second electronic device, the local mode playing the game by executing in the second electronic device the game based on the first data;
transmit, via the communication circuit to the second electronic device, second data for providing a cloud mode of the game to the second electronic device, based on the reception of the signal, the cloud mode playing the game by receiving, by the second electronic device, at least one content of the game executed in a third electronic device.

2. The non-transitory computer readable storage medium of claim 1, wherein the first data includes an application programming interface (API) for identifying whether the local mode is available in the second electronic device or not,
wherein the signal is obtained based on the API and is transmitted from the second electronic device to the first electronic device.

3. The non-transitory computer readable storage medium of claim 2, wherein the first data further includes information for installing the game in the second electronic device to play the game through the local mode in the second electronic device.

4. The non-transitory computer readable storage medium of claim 3, wherein the API in the first data is received at the second electronic device before the information in the first data is received at the second electronic device.

5. The non-transitory computer readable storage medium of claim 4, wherein the one or more programs comprise instructions which, when executed by the at least one processor of the first electronic device, cause the first electronic device to:
receive, from the second electronic device via the communication circuit, the signal obtained based on the API in the first data;
identify that the local mode is not available in the second electronic device, by identifying that the information in the first data is not fully received, based on the signal; and
transmit, based on identifying that the local mode is not available in the second electronic device, the second data, via the communication circuit to the second electronic device.

6. The non-transitory computer readable storage medium of claim 4, wherein the one or more programs comprises instructions which, when executed by the at least one processor of the first electronic device, cause the first electronic device to:
receive, from the second electronic device via the communication circuit, the signal obtained by the API in the first data;
identify that the local mode is not available in the second electronic device, by identifying, based on the signal, that an error is occurred while installing the game in the second electronic device based on the information in the first data for the local mode; and
transmit, based on identifying that the local mode is not available in the second electronic device, the second data, via the communication circuit to the second electronic device.

7. The non-transitory computer readable storage medium of claim 4, wherein the one or more programs comprises instructions which, when executed by the at least one processor of the first electronic device, cause the first electronic device to:
receive, from the second electronic device via the communication circuit, the signal obtained based on the API in the first data;
identify that the local mode is not available in the second electronic device, by identifying, based on the signal, that an error is occurred while playing the game in the second electronic device through the local mode; and
transmit, based on identifying that the local mode is not available in the second electronic device, the second data, via the communication circuit to the second electronic device.

8. The non-transitory computer readable storage medium of claim 1, wherein the one or more programs comprises instructions which, when executed by the at least one processor of the first electronic device, further cause the first electronic device to:
receive, from the second electronic device via the communication circuit, another signal for determining whether maintaining to provide the cloud mode to the second electronic device or not, after transmitting the second data;
determine, based on the other signal, ceasing to provide the cloud mode to the second electronic device; and
execute at least one operation for ceasing to play the game in the second electronic device through the cloud mode, based on the determination.

9. The non-transitory computer readable storage medium of claim 8, wherein the second data includes an application programming interface (API) for identifying whether maintaining to provide the cloud mode to the second electronic device, and
wherein the other signal is obtained based on the API and is transmitted from the second electronic device to the first electronic device.

10. The non-transitory computer readable storage medium of claim 9, wherein the API is transmitted from the first electronic device to the second electronic device before playing the game in the second electronic device through the cloud mode.

11. The non-transitory computer readable storage medium of claim 10, wherein the one or more programs comprise instructions which, when executed by the at least one processor of the first electronic device, further cause the first electronic device to:
receive, from the second electronic device via the communication circuit, the other signal obtained based on the API in the second data; and
determine to cease providing the cloud mode to the second electronic device, by identifying based on the other signal that a period capable of playing the game in the second electronic device through the cloud mode expires.

12. The non-transitory computer readable storage medium of claim 10, wherein the one or more programs comprises instructions which, when executed by the at least one processor of the first electronic device, further cause the first electronic device to:
receive, from the second electronic device via the communication circuit, the other signal obtained based on the API in the second data; and
determine to cease providing the cloud mode to the second electronic device, by identifying based on the other signal not to play the game in the second electronic device through the cloud mode during a predetermined period after receiving the second data.

13. The non-transitory computer readable storage medium of claim 1, wherein the one or more programs comprises instructions which, when executed by the at least one processor of the first electronic device, further cause the first electronic device to:
identify, after transmitting the second data, whether identification information of a user of the second electronic device is used for playing the game in a fourth electronic device distinct from the second electronic device through the local mode; and
transmit, based on identifying that the identification information is used for playing the game in the fourth electronic device through the local mode, third data for ceasing to play the game in the second electronic device through the cloud mode.

14. A non-transitory computer readable storage medium storing one or more programs, the one or more programs comprising instructions which, when executed by at least one processor of a first electronic device with at least one display, at least one memory, and a communication circuit, cause the first electronic device to:
store in the at least one memory at least portion of first data for an execution of a game;
receive, while a local mode playing the game by executing the game in the first electronic device by using the first data stored in the first data is unavailable, second data for accessing a third electronic device for a cloud mode of the game playing the game by receiving at least one content of the game executed in the third electronic device by the first electronic device; and
display, via the at least one display, the at least one content received via the communication circuit from the third electronic device by using a communication connection between the first electronic device and the third electronic device, the communication connection established based on the second data for the play of the game through the cloud mode.

15. The non-transitory computer readable storage medium of claim 14, wherein the at least portion of the first data stored in the at least one memory includes an application programming interface (API) for identifying whether the local mode is available in the first electronic device, and
wherein the one or more programs comprises instructions which, when executed by the at least one processor of the first electronic device, further cause the first electronic device to:
transmit, based on the API, a signal for indicating whether the local mode is available in the first electronic device or not, via the communication circuit to the second electronic device; and
receive, in response to the signal, the second data via the communication circuit from the second electronic device.

16. The non-transitory computer readable storage medium of claim 15, wherein the first data further includes information for installing the game in the first electronic device for playing the game in the first electronic device through the local mode,
wherein the API in the first data is received at the first electronic device, before the information in the first data is received at the first electronic device.

17. The non-transitory computer readable storage medium of claim 16, wherein the signal includes data for indicating that the information in the first data is not fully received at the first electronic device, and
wherein the data is obtained based on the API included in the at least portion of the first data.

18. The non-transitory computer readable storage medium of claim 16, wherein the signal includes data for indicating that an error is caused while installing the game in the first electronic device based on the information in the first data, and
wherein the data is obtained based on the API.

19. The non-transitory computer readable storage medium of claim 14, wherein the second data includes an application programming interface for identifying whether maintaining to provide the cloud mode in the first electronic device, and
wherein the one or more programs comprises instructions which, when executed by the at least one processor of the first electronic device, further cause the first electronic device to:
transmit, via the communication circuit to the second electronic device, another signal for determining whether maintaining to provide the cloud mode in the first electronic device, the other signal is obtained based on the API in the second data; and
maintain or cease to play the game in the first electronic device through the cloud mode, according to a determination executed in the second electronic device based on the other signal.

20. A method for operating a first electronic device with at least one display, at least one memory, and a communication circuit, the method comprising:
storing in the at least one memory at least portion of first data for an execution of a game;
receiving, while a local mode playing the game by executing the game in the first electronic device by using the first data stored in the first data is unavailable, second data for accessing a third electronic device for a cloud mode of the game playing the game by receiving at least one content of the game executed in the third electronic device by the first electronic device; and
displaying, via the at least one display, the at least one content received via the communication circuit from the third electronic device by using a communication connection between the first electronic device and the third electronic device, the communication connection established based on the second data for the play of the game through the cloud mode.
